(19) United States
(12) Patent Application Publication
(10) Pub. No.: US 2025/0277934 A1
(43) Pub. Date: Sep. 4, 2025

(54) OPTICAL WAVEGUIDE STRUCTURE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Yuki KAMATA, Nisshin-shi (JP); Masashige SATO, Nisshin-shi (JP); Koichi OYAMA, Nisshin-shi (JP)

(21) Appl. No.: 19/032,642

(22) Filed: Jan. 21, 2025

(30) Foreign Application Priority Data
Mar. 1, 2024 (JP) 2024-031380

(51) Int. Cl. G02B 6/12; G01M 11/02

(52) U.S. Cl. CPC G02B 6/12011; G01M 11/0207; G02B 6/12021

(57) ABSTRACT

In an optical waveguide structure, light emitting portions are respectively disposed on waveguides extending in a first direction on a substrate. The light emitting portions are configured to emit a part of lights that have passed through phase adjusters and propagate through the waveguides as emitted lights in a direction different from a direction in which optical antenna units emit the lights. A photoelectric converter is disposed on the substrate, and is disposed on one side, the other side, or both sides in a second direction that is perpendicular to the first direction with respect to all of the light emitting portions. A position of the photoelectric converter is set so that an emitted beam formed by the emitted lights from the light emitting portions is incident on the photoelectric converter when phases of the emitted lights are matched with each other.

### CROSS REFERENCE TO RELATED APPLICATION

The present application claims the benefit of priority from Japanese Patent Application No. 2024-031380 filed on Mar. 1, 2024. The entire disclosure of the above application is incorporated herein by reference.

### TECHNICAL FIELD

The present disclosure relates to an optical waveguide structure including a plurality of waveguides.

### BACKGROUND

There has been known a phase measurement device that acquires lights emitted from a plurality of waveguides and measures a phase variation that occurs in the waveguides.

### SUMMARY

The present disclosure provides an optical waveguide structure including a substrate, a plurality of waveguides, a plurality of phase adjusters, a plurality of optical antenna units, a plurality of light emitting portions, and a photoelectric converter. The waveguides are disposed on the substrate, extend in a first direction, and are arranged at a uniform pitch in a second direction that is perpendicular to the first direction. The phase adjusters, the optical antenna units, and the light emitting portions are respectively disposed on the waveguides on the substrate. The light emitting portions are configured to emit a part of respective lights that have passed through the phase adjusters and propagate through the waveguides as emitted lights in a direction different from a direction in which the optical antenna units emit the respective lights from the waveguides. The photoelectric converter is disposed on the substrate, and is disposed on one side, the other side, or both sides in the second direction with respect to all of the light emitting portions. A position of the photoelectric converter is set so that an emitted beam formed by the emitted lights from the light emitting portions is incident on the photoelectric converter when phases of the emitted lights are matched with each other.

### BRIEF DESCRIPTION OF DRAWINGS

Objects, features and advantages of the present disclosure will become apparent from the following detailed description made with reference to the accompanying drawings. In the drawings:

FIG. 1 is a conceptual diagram illustrating a schematic configuration of a general optical phased array;

FIG. 2 is a schematic diagram illustrating a configuration of a first reference example in a state in which phases of guided lights propagating through a plurality of waveguides vary and are not matched;

FIG. 3 is a diagram showing a distribution of light intensities of emitted lights with respect to a direction from optical antenna units of an optical phased array in the state shown in FIG. 2;

FIG. 4 is a schematic diagram illustrating the configuration of the first reference example in a state in which the phases of the guided lights propagating through the plurality of waveguides are matched;

FIG. 5 is a diagram showing a distribution of light intensities of emitted lights with respect to a direction from optical antenna units of an optical phased array in the state shown in FIG. 4;

FIG. 6 is a first diagram illustrating a schematic configuration of a second reference example using a conceptual diagram similar to that of FIG. 1;

FIG. 7 is a second diagram illustrating a schematic configuration of the second reference example, which is a top view in which a portion VII in FIG. 6 is extracted and the number of waveguides is reduced;

FIG. 8 is a perspective view schematically illustrating optical antenna units disposed on waveguides in the second reference example and a first embodiment;

FIG. 9 is a conceptual diagram showing a schematic configuration of an optical waveguide structure according to the first embodiment;

FIG. 10 is a diagram illustrating a portion X in FIG. 9 and is a top view illustrating a part of an optical phased array and a photoelectric converter disposed on a substrate in the optical waveguide structure according to the first embodiment;

FIG. 11 is a cross-sectional view taken along line XI-XI in FIG. 10 in the first embodiment;

FIG. 12 is an enlarged cross-sectional view illustrating a portion XII in FIG. 10 in the first embodiment;

FIG. 13 is a cross-sectional view taken along line XIII-XIII in FIG. 10 in the first embodiment;

FIG. 14 is a top view similar to FIG. 10, illustrating a state in which phases of emitted lights emitted from respective light emitting portions of the optical phased array vary and are not matched;

FIG. 15 is a light intensity distribution diagram showing the relationship between a direction from a center of a light emitting portion group in a planar view along a third direction and a light intensity of the emitted lights in the state shown in FIG. 14;

FIG. 16 is a top view similar to FIG. 10, illustrating a state in which the phases of the emitted lights emitted from the respective light emitting portions of the optical phased array are matched;

FIG. 17 is a light intensity distribution diagram showing the relationship between the direction from the center of the light emitting portion group in the planar view and the light intensity of the emitted lights in the state shown in FIG. 16;

FIG. 18 is a top view illustrating a part of an optical phased array and a photoelectric converter disposed on a substrate in an optical waveguide structure according to a second embodiment;

FIG. 19 is an enlarged cross-sectional view illustrating a portion XIX in FIG. 18 in the second embodiment;

FIG. 20 is a top view illustrating a part of an optical phased array and a photoelectric converter disposed on a substrate in an optical waveguide structure according to a third embodiment;

FIG. 21 is a cross-sectional view taken along line XXI-XXI in FIG. 20 in the third embodiment;

FIG. 22 is an enlarged cross-sectional view illustrating a portion XXII in FIG. 20 in the third embodiment;

FIG. 23 is a light intensity distribution diagram showing the relationship between the direction from the center of the light emitting portion group in the planar view and the light intensity of the emitted lights in the state in which the phases of the emitted lights emitted from the respective light emitting portions are matched;

FIG. 24 is a top view illustrating a part of an optical phased array and a photoelectric converter disposed on a substrate in an optical waveguide structure according to a fourth embodiment;

FIG. 25 is a cross-sectional view taken along line XXV-XXV in FIG. 24 in the fourth embodiment;

FIG. 26 is a top view illustrating a part of an optical phased array and photoelectric converters disposed on a substrate in an optical waveguide structure according to a fifth embodiment;

FIG. 27 is a top view illustrating a part of an optical phased array and a photoelectric converter disposed on a substrate in an optical waveguide structure according to a sixth embodiment;

FIG. 28 is a top view illustrating a part of an optical phased array and a photoelectric converter disposed on a substrate in an optical waveguide structure according to a seventh embodiment;

FIG. 29 is a top view illustrating a part of an optical phased array and a photoelectric converter disposed on a substrate in an optical waveguide structure according to an eighth embodiment;

FIG. 30 is a top view illustrating a part of an optical phased array and a photoelectric converters disposed on a substrate in an optical waveguide structure according to a ninth embodiment; and

FIG. 31 is a top view illustrating a part of an optical phased array and photoelectric converters disposed on a substrate in an optical waveguide structure according to another embodiment.

### DETAILED DESCRIPTION

Next, a relevant technology is described only for understanding the following embodiments. In an optical phased array composed of a plurality of waveguides, phases of guided lights propagating through the waveguides vary due to processing errors during manufacturing, component variations, and other factors. Therefore, it is necessary to perform a correction for restricting the phase variation of the guided lights in the waveguides. In order to perform correction to restrict the phase variation of the guided lights, it is conceivable to use a phase measurement device.

The phase measurement device acquires emitted lights emitted from the waveguides and measures the phase variation that occurs in the waveguides. The phase measurement device may include a camera, separate from the optical phased array, as an emitted light acquisition unit that acquires the emitted lights emitted from the optical phased array, and may calculate the phase variation that occurs in the waveguides based on image information obtained from the camera.

However, the phase measurement device described above requires the camera for acquiring the emitted lights in addition to a chip including the optical phased array, which makes the device as a whole large and complex. Therefore, it is considered preferable to equip a chip with an optical phased array with a function of acquiring guided lights from waveguides included in the optical phased array.

In order to enable a chip with an optical phased array to acquire guided lights from waveguides, it is conceivable to provide light-coupling waveguides for acquiring the guided lights, which are optically coupled to each waveguide, between the waveguides of the optical phased array. However, this configuration has the following disadvantages. In the above-described configuration, the light-coupling waveguides and various elements connected to the light-coupling waveguides are disposed between the waveguides that propagate the guided lights, resulting in limitations on the reduction of the pitch between the waveguides. Consequently, if the reduction of the pitch between the waveguides is limited, a scanning range of a beam formed by the emitted lights from the optical phased array is also limited. As a result of detailed studies by the present inventors, the above findings were discovered.

An optical waveguide structure according to an aspect of the present disclosure includes a substrate, a plurality of waveguides, a plurality of phase adjusters, a plurality of optical antenna units, a plurality of light emitting portions, and a photoelectric converter. The waveguides are disposed on the substrate, extend in a first direction, are arranged at a uniform pitch in a second direction that is perpendicular to the first direction, and are configured to propagate respective lights. The phase adjusters are respectively disposed on the waveguides on the substrate, and are configured to control phases of the respective lights propagating through the waveguides. The optical antenna units are respectively disposed on the waveguides on the substrate, and are configured to emit the respective lights that have passed through the phase adjusters and propagate through the waveguides in an antenna unit emitting direction. The light emitting portions are respectively disposed on the waveguides on the substrate, and are configured to emit a part of the respective lights that have passed through the phase adjusters and propagate through the waveguides as emitted lights in a direction different from the antenna unit emitting direction. The photoelectric converter is disposed on the substrate, is disposed on one side, the other side, or both sides in the second direction with respect to all of the light emitting portions, and is configured to output an electrical signal corresponding to an intensity of a light incident on the photoelectric converter. A position of the photoelectric converter is set so that an emitted beam formed by the emitted lights from the light emitting portions is incident on the photoelectric converter when phases of the emitted lights are matched with each other.

In this way, a part of the lights propagating through the waveguides are emitted as the emitted lights from the light emitting portions, and when the phases of the emitted lights are matched with each other, the emitted beam formed by the emitted lights is incident on the photoelectric converter. Therefore, the photoelectric converter can provide a function of acquiring the lights propagating through the waveguides in order to perform correction for restricting the phase variation of the lights. Since the photoelectric converter is disposed on the same substrate as the waveguides, it is possible to provide a chip having the waveguides with the function of acquiring the lights propagating through the waveguides.

Furthermore, since the photoelectric converter is disposed on the one side, the other side, or both sides in the second direction with respect to all of the of light emitting portions, the arrangement of the waveguides is not hindered from narrowing the pitch. For example, compared to a case where various elements such as photoelectric converters are disposed between waveguides that propagate guided lights, it can be said that the arrangement of the waveguides is less likely to be hindered from having a narrow pitch.

### Explanation of Optical Phased Array

Since an optical waveguide structure 10 described in each embodiment below includes an optical phased array, a general optical phased array 70 will be described. The optical phased array may be abbreviated as OPA.

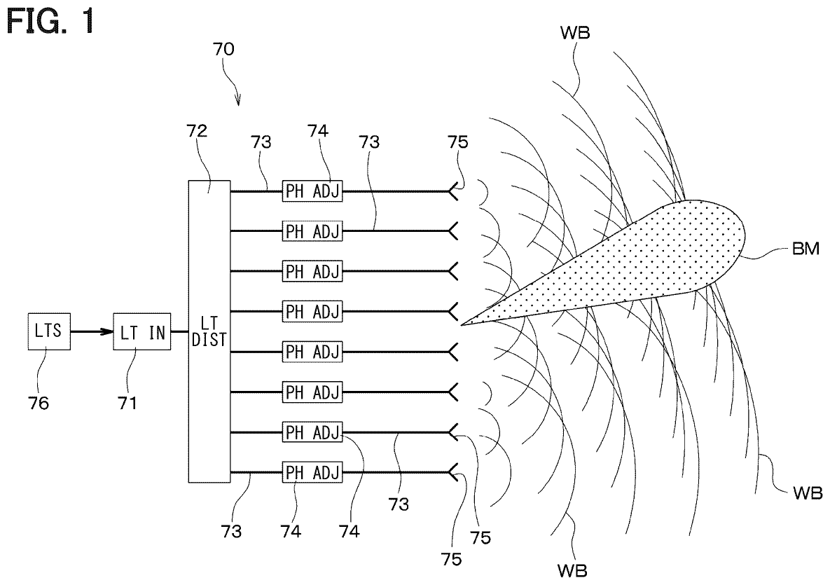

As shown in FIG. 1, the optical phased array 70 is a device capable of controlling a direction and a shape of a beam BM emitted from the optical phased array 70 without using a mechanical mechanism. The optical phased array 70 includes a light incident unit (LT IN) 71, a light distribution unit (LT DIST) 72 connected to the light incident unit 71, a plurality of waveguides 73 connected to the light distribution unit 72 and arranged in parallel with each other, a plurality of phase adjusters (PH ADJ) 74, and a plurality of optical antenna units 75. The phase adjusters 74 are respectively disposed midway on the waveguides 73, and configured to adjust phases of respective guided lights propagating through the waveguides 73. The optical antenna units 75 are respectively disposed at end portions of the waveguides 73 and configured to respectively emit the guided lights from the waveguides 73.

The light incident unit 71, the light distribution unit 72, the plurality of waveguides 73, the plurality of phase adjusters 74, and the plurality of optical antenna units 75 are formed, for example, by being laminated on a silicon (Si) substrate (not shown).

For example, a light emitted from a light source (LTS) 76 such as an infrared laser light source is incident on the light incident unit 71 of the optical phased array 70, and the incident light is distributed to the waveguides 73 by the light distribution unit 72. The phases of guided lights, which are lights distributed by the light distribution unit 72 and propagate through the respective waveguides 73, are respectively adjusted by the phase adjusters 74, and the guided lights after the phase adjustment travel in the waveguides 73 toward the optical antenna units 75 and are emitted from the optical antenna units 75 to the outside of the optical phased array 70.

The optical phased array 70 can form the beam BM from light waves WB emitted from the optical antenna units 75 in any direction by regularly controlling the phases of the guided lights propagating through the waveguides 73 with the phase adjusters 74.

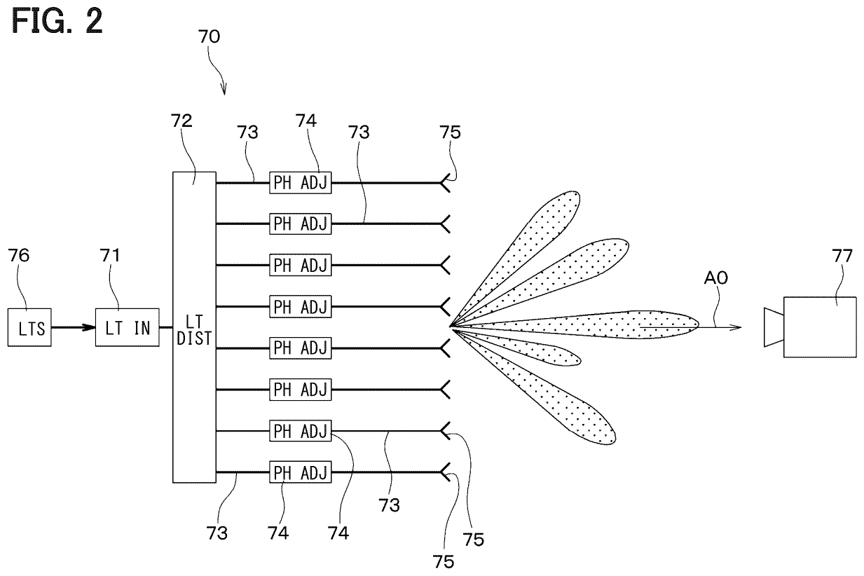

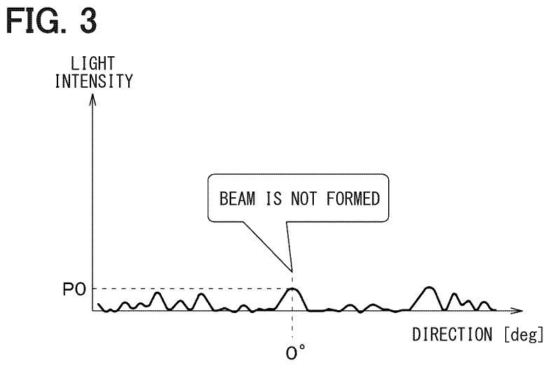

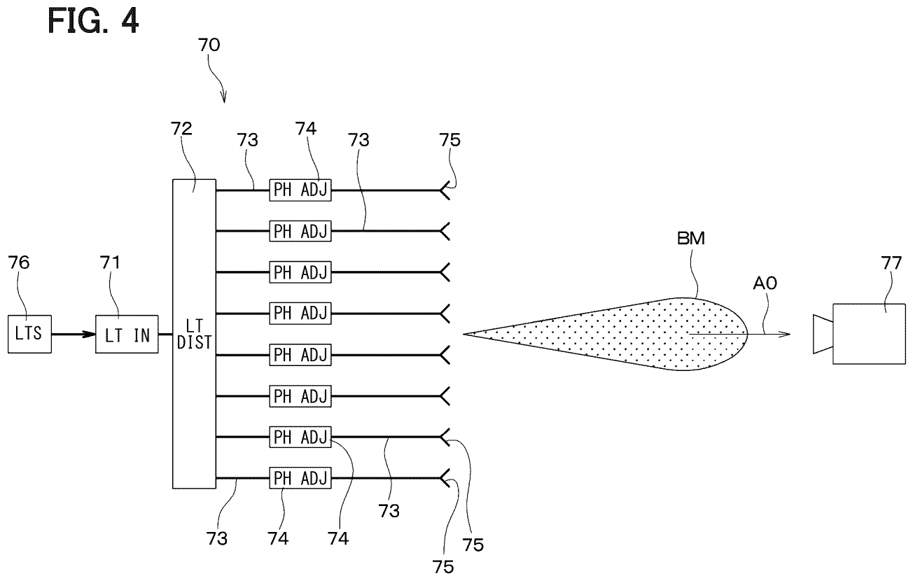

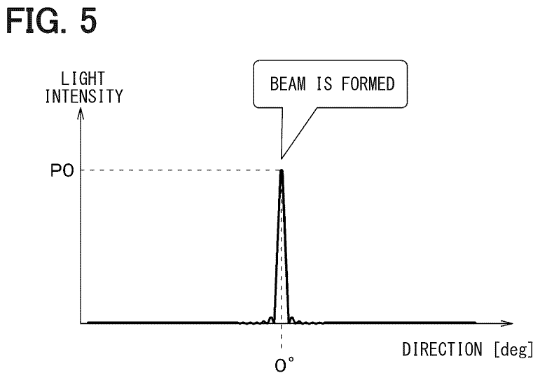

For example, if the phases of the guided lights are not controlled at all by the phase adjusters 74 and the guided lights are emitted from the optical antenna units 75, a concentrated beam BM is not formed as shown in FIG. 2 and FIG. 3. This is because the phases of the guided lights propagating through the waveguides vary irregularly due to processing errors and component variations during the manufacture of the optical phased array 70. An arrow A0 in FIG. 2 and FIG. 4 described later indicates a direction of 0 degrees indicated on the horizontal axis in FIG. 3 and FIG. 5 described later.

Therefore, as a prerequisite for using the optical phased array 70, phase correction is required to eliminate variations in initial phases of the guided lights caused by processing errors, component variations, and the like during the manufacture of the optical phased array 70. The initial phases of the guided lights are the phases of the guided lights before being adjusted by the phase adjusters 74. When the phase correction is performed and the phases of the emitted lights respectively emitted from the optical antenna units 75 are matched, a single unified beam BM is formed in the direction of 0 degrees, as shown in FIG. 4 and FIG. 5.

For example, as a configuration for performing the phase correction, a first reference example described below can be considered. In the first reference example, as shown in FIG. 2 and FIG. 4, an infrared camera 77 is provided separately from a chip including the optical phased array 70. The infrared camera 77 is disposed at a direction of 0 degrees relative to the optical phased array 70 and is configured so as to be able to detect the emitted lights from the optical antenna units 75 from the direction of 0 degrees. Then, while the emitted lights from the optical antenna units 75 are monitored by the infrared camera 77, the phases of the guided lights are adjusted by the respective phase adjusters 74 so that the light intensity P0 at the direction of 0 degrees is maximized, as shown in FIG. 5. As a result of this adjustment, as shown in FIG. 4, one beam BM is formed in the direction of 0 degrees, completing the phase correction.

In the above-described first reference example, although it is possible to perform the phase correction, it is necessary to provide the infrared camera 77 separately from the chip including the optical phased array 70, and therefore the entire device performing the phase correction becomes large-scale. Therefore, there is a demand for a technique that can monitor the phases of the guided lights in the respective waveguides 73 within the chip including the optical phased array 70. As a technique that meets this demand, the following second reference example can be considered.

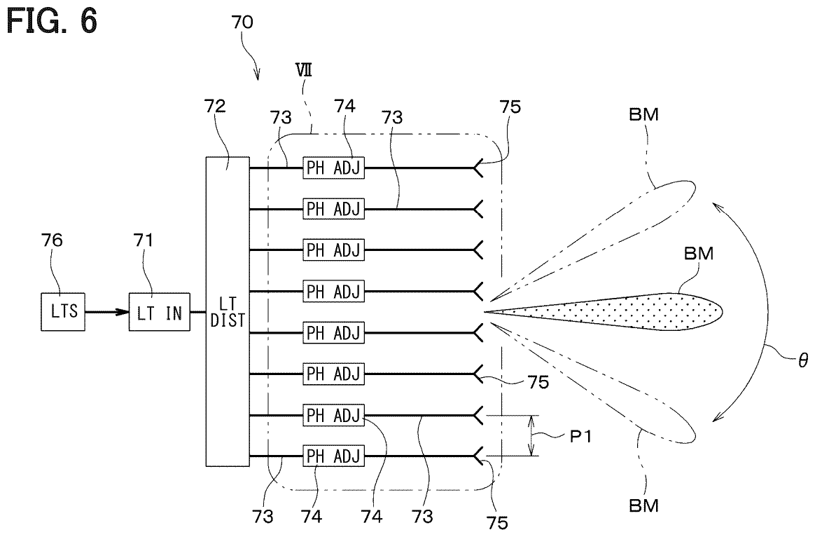

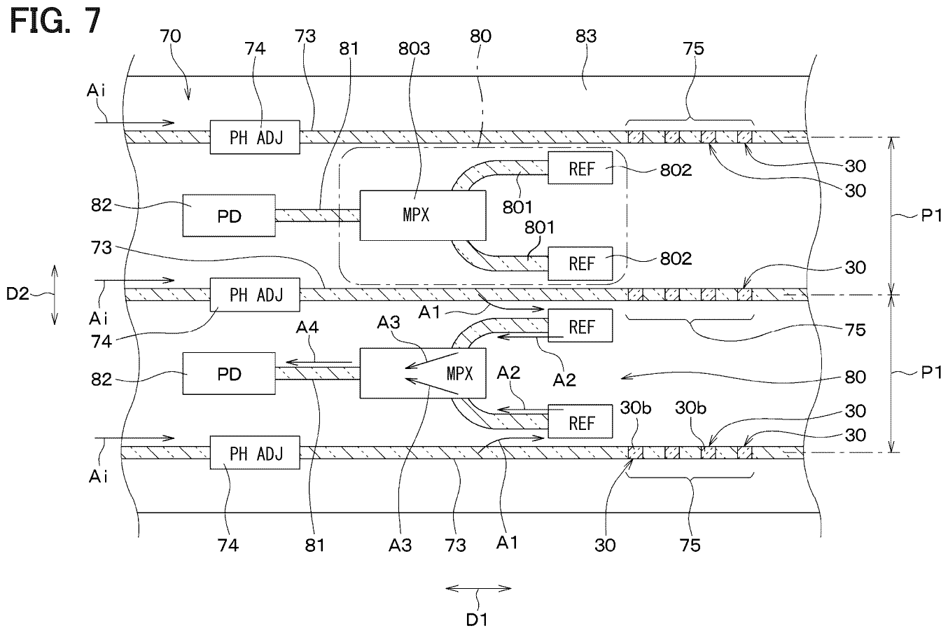

In the second reference example, as shown in FIG. 6 and FIG. 7, guided light acquiring units 80, relay waveguides 81, and photodiodes (PD) 82 are respectively provided between the waveguides 73 of the optical phased array 70. The guided light acquiring units 80, the relay waveguides 81, the photodiodes 82, and the optical phased array 70 are formed on a common Si substrate 83. Light is incident on each of the waveguides 73 of the optical phased array 70 from the light distribution unit 72 as indicated by arrows Ai.

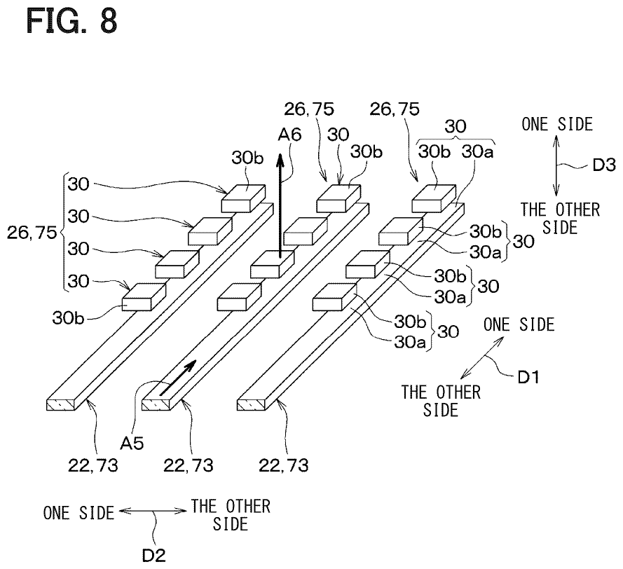

In FIG. 7 and FIG. 8 described later, only core portions of the waveguides 73 are shown, and a cladding layer around the core portions is omitted. The method of omitting the cladding layer is also used for illustrating the relay waveguides 81 and optical coupled waveguides 801 described below.

Each of the guided light acquiring units 80 includes a pair of optical coupled waveguides 801, a pair of reflectors (REF) 802, and a multiplexer (MPX) 803. The pair of optical coupled waveguides 801 are disposed so as to be optically coupled to one and the other of a pair of waveguides 73 that sandwich the guided light acquiring unit 80. Therefore, portions of the guided lights that pass through the phase adjusters 74 in the pair of waveguides 73 and immediately before reaching the optical antenna units 75 move from the pair of waveguides 73 to the optical coupled waveguide 801 as indicated by arrows A1.

The guided lights transferred to the optical coupled waveguide 801 are reflected by the reflector 802 as indicated by arrows A2, and are multiplexed by the multiplexer 803 as indicated by arrows A3. Furthermore, the light multiplexed by the multiplexer 803 is input from the multiplexer 803 to the photodiode 82 through the relay waveguide 81 as indicated by an arrow A4. In phase correction of the guided lights, phases of the guided lights are adjusted by the respective phase adjusters 74 so that outputs of the respective photodiodes 82, which correspond to light intensities of the lights input to the respective photodiode 82, become maximum at the respective photodiodes 82. As a result of this adjustment, one beam BM is formed in the direction of 0 degrees as shown by a solid line in FIG. 6, and the phase correction is completed.

In the second reference example, since the guided light acquiring units 80 and the like are disposed between the waveguides 73 as shown in FIG. 7, a pitch P1 of the waveguides 73 is larger than the size of the guided light acquiring unit 80. Since the guided light acquiring unit 80 includes the reflectors 802 and the multiplexer 803, the size of the guided light acquiring unit 80 is large.

Therefore, in the second reference example, the guided light acquiring unit 80 hinders narrowing of the pitch P1 of the waveguides 73. In other words, the second reference example has a disadvantage that the narrowing of the pitch of the waveguides 73 is limited. A beam scanning range θ in which the beam BM can be scanned becomes wider as the pitch of the optical antenna units 75, which is the same as the pitch P1 of the waveguides 73, becomes smaller. Therefore, in the second reference example in which the narrowing of the pitch of the waveguides 73 is limited, the beam scanning range θ is limited due to the guided light acquiring units 80 and the like disposed between the waveguides 73.

Note that, the beam BM indicated by two-dot chain lines in FIG. 6 represent the beam BM scanned in a direction other than the direction of 0 degrees. In addition, in FIG. 7, for the sake of simplicity, the number of waveguides 73 shown in FIG. 6 is reduced to three.

As shown in FIG. 8, the optical antenna unit 75 in the second reference example has a plurality of light exit sections 30 arranged along each of the waveguides 73 so that light is output from the waveguides 73. Each of the light exit sections 30 is composed of a first light exit component 30a that constitutes a part of the core portion of the waveguide 73 in the longitudinal direction of the waveguide 73, and a second light exit component 30b that is a diffraction grating adjacent to the first light exit component 30a.

Therefore, the first light exit component 30a and the second light exit component 30b form a pair to constitute the light exit section 30, and the second light exit components 30b are arranged along the waveguide 73 in which the light exit sections 30 to which they belong are provided. In detail, each of the second light exit components 30b is disposed adjacent to the first light exit component 30a so as to diffract and emit the light that has leaked out from the first light exit component 30a. Therefore, the guided light propagating in the waveguide 73 as indicated by an arrow A5 is emitted from each of the light exit sections 30 to the outside of the waveguide 73 as indicated by an arrow A6. Therefore, the direction of 0 degrees is on the front side of the paper in FIG. 7.

The first light exit components 30a may be made of, for example, Si, and the second light exit components 30b, which are diffraction gratings, may be made of, for example, silicon nitride (SIN). In FIG. 7, the waveguides 73, 801, and 81 and the second light exit components 30b are hatched for ease of understanding. The longitudinal direction of the waveguides 73 coincide with the first direction D1 in FIG. 7 and FIG. 8.

An optical waveguide structure 10 including an optical phased array 18 of each embodiment described below in the present disclosure is configured in consideration of the above-described disadvantage of the second reference example in that narrowing the pitch of the waveguides 73 is limited.

Hereinafter, embodiments will be described with reference to the drawings. In the following embodiments, identical or equivalent elements are denoted by the same reference numerals as each other in the drawings.

### First Embodiment

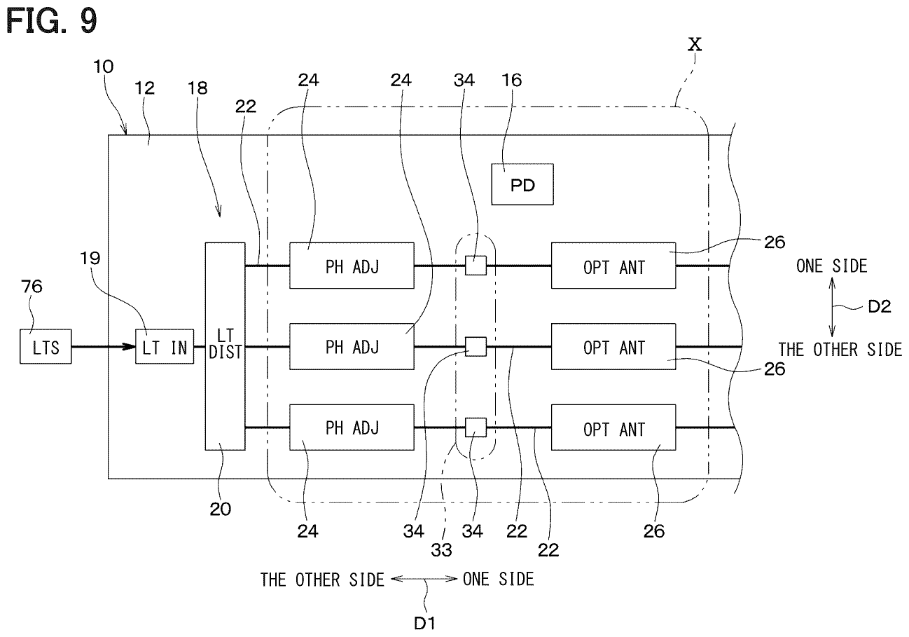

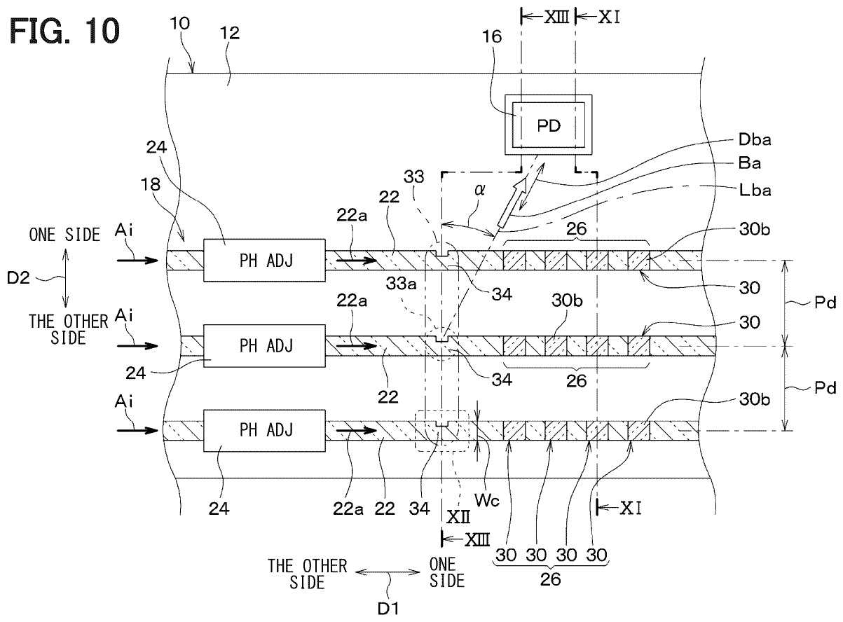

As shown in FIG. 9 and FIG. 10, an optical waveguide structure 10 of the present embodiment includes a substrate 12, a photoelectric converter (PD) 16, an optical phased array 18, and the like. The photoelectric converter 16 and optical phased array 18 are formed on the substrate 12 by silicon photonics technology, and the optical waveguide structure 10 is configured as a single optical integrated chip.

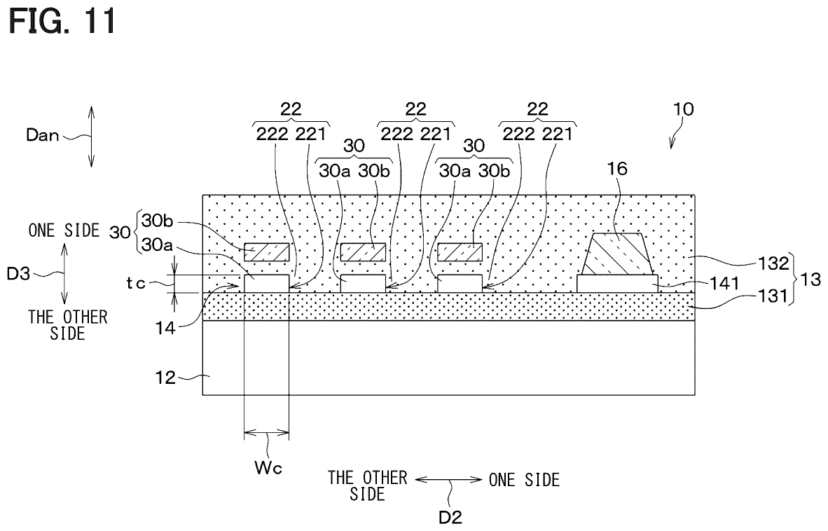

In the description of the present embodiment, a first direction D1, a second direction D2, and a third direction D3 shown in FIGS. 9 to 11 may be used to indicate directions in the optical waveguide structure 10. The first direction D1, the second direction D2, and the third direction D3 intersect with each other, or more precisely, are perpendicular to each other. In addition, in FIG. 10 and subsequent figures corresponding to FIG. 10, a cladding layer 13 shown in FIG. 11, for example, is omitted, and therefore a plurality of waveguides 22 of the optical phased array 18 are illustrated only by core portions 221 included in the waveguides 22.

The substrate 12 is made of, for example, silicon (Si), and is formed in a rectangular plate shape extending in the first direction D1 and the second direction D2. The photoelectric converter 16 and the optical phased array 18 are formed on the substrate 12. In other words, the photoelectric converter 16 and the optical phased array 18 are arranged on one side of the substrate 12 in the third direction D3 and are configured to be integrated with the substrate 12.

Specifically, the optical waveguide structure 10 has a laminated structure, which includes the substrate 12, a lower cladding layer 131, an upper cladding layer 132, and a core layer 14, as shown in FIG. 11. The lower cladding layer 131 and the upper cladding layer 132 are made of, for example, silicon oxide (SiO₂), and the core layer 14 is made of, for example, Si. Therefore, for example, the waveguides 22 included in the optical phased array 18 are made of the same material.

In the laminated structure of the optical waveguide structure 10, the lower cladding layer 131 is laminated on the one side of the substrate 12 in the third direction D3, and the core layer 14 is laminated on one side of a portion of the lower cladding layer 131 in the third direction D3. In addition, the upper cladding layer 132 is laminated on one side of the lower cladding layer 131 in the third direction D3, and is also laminated on one side of the core layer 14 in the third direction D3 so as to sandwich the core layer 14 between the upper cladding layer 132 and the lower cladding layer 131. In the description of the present embodiment, the lower cladding layer 131 and the upper cladding layer 132 may be collectively referred to as the cladding layer 13.

As shown in FIG. 9 and FIG. 10, the optical phased array 18 includes a light incident unit (LT IN) 19, a light distribution unit (LT DIST) 20, the plurality of waveguides 22, a plurality of phase adjusters (PH ADJ) 24, a plurality of optical antenna units (OPT ANT) 26, and a plurality of light emitting portions 34.

The light incident unit 19, the light distribution unit 20, and the plurality of waveguides 22 are formed by the core layer 14 and a portion of the cladding layer 13 surrounding the core layer 14 in FIG. 11. For example, as shown in FIG. 11, each of the plurality of waveguides 22 includes the core portion 221 that is formed corresponding to each of the waveguides 22 within the core layer 14, and a cladding portion 222 surrounding the core portion 221 within the cladding layer 13.

As shown in FIGS. 9 to 11, the light incident unit 19 is a portion of the optical phased array 18 on which a light emitted from a light source (LTS) 76, such as an infrared laser light source, is incident. The light distribution unit 20 is disposed on one side of the light incident unit 19 in the first direction D1, and is disposed on the other side in the first direction D1 with respect to each of the plurality of waveguides 22. In short, the light distribution unit 20 is disposed between the light incident unit 19 and the plurality of waveguides 22. The light incident unit 19 and the plurality of waveguides 22 are each connected to the light distribution unit 20. Due to this connection relationship, the light distribution unit 20 distributes the incident light incident on the light incident unit 19 to each of the plurality of waveguides 22 as indicated by arrows Ai.

Each of the waveguides 22 propagates the light incident from the light distribution unit 20. The light propagating through each of the waveguides 22 may be referred to as a guided light 22a. Each of the waveguides 22 extends in the first direction D1. In detail, each of the waveguides 22 extends linearly along the first direction D1 in parallel with one another. For example, in the present embodiment, the waveguides 22 are formed to have the same shape.

A cross-sectional shape of the core portion 221 of the waveguide 22 in a cross section perpendicular to the first direction D1, for example, a cross-sectional shape of the core portion 221 shown in FIG. 11, is rectangular. For example, a thickness dimension tc in the third direction D3 of the cross-sectional shape of the core portion 221 is “tc=0.21 μm”, and a width dimension Wc in the second direction D2 is “Wc=0.5 μm” except for a core width changed portion 341 described later.

The waveguides 22 are arranged at a uniform pitch Pd in the second direction D2. In other words, the pitch Pd of the waveguides 22 is uniform, and intervals between any of the waveguides 22 are the same. For example, the pitch Pd of the waveguide 22 in the present embodiment is set to “Pd=1.5 μm”.

The phase adjusters 24 are respectively disposed on the waveguides 22 on the substrate 12. In detail, the phase adjusters 24 are provided one for each waveguide 22. Therefore, the optical phased array 18 has the same number of phase adjusters 24 as the waveguides 22.

Each of the phase adjusters 24 controls the phase of the guided light 22a propagating through the waveguide 22 in which each of the phase adjuster 24 is disposed. For example, the phase adjuster 24 changes a refractive index of a material constituting a adjusted portion of the waveguide 22 on which the phase adjuster 24 is disposed, by using an electro-optical effect or a thermo-optical effect, and changes the phase of the guided light 22a passing through the adjusted portion due to the change in refractive index.

When the phase adjuster 24 is configured to utilize the electro-optic effect, the phase adjuster 24 has a pair of electrodes arranged on either side of the waveguide 22, and the phase of the guided light 22a is changed by applying a voltage between the pair of electrodes. In addition, when the phase adjuster 24 is configured to utilize the thermo-optical effect, the phase adjuster 24 has a heater that can heat the adjusted portion of the waveguide 22 by passing an electric current through it, and the phase of the guided light 22a is changed by heating the adjusted portion by the heater.

The optical antenna units 26 are respectively disposed on the waveguides 22 on the substrate 12. In detail, the optical antenna units 26 are provided one for each of the waveguides 22. Therefore, the optical phased array 18 has the same number of optical antenna units 26 as the waveguides 22.

Each of the optical antenna units 26 emits the guided light 22a propagating through the waveguide 22 in which each of the optical antenna unit 26 is disposed, from that waveguide 22. In detail, the optical antenna unit 26 is arranged on the opposite side of the phase adjuster 24 from the light distribution unit 20, in other words, on the one side of the first direction D1 from the phase adjuster 24, so that the guided light 22a that has passed through the phase adjuster 24 and propagates through the waveguide 22 is emitted from the waveguide 22.

Specifically, each of the optical antenna units 26 is configured as shown in FIG. 8 and FIG. 10. In other words, in the present embodiment, as in the second reference example described above, each of the optical antenna units 26 has a plurality of light exit sections 30 arranged along each of the waveguides 22 and emits light from each of the waveguides 22.

Each of the light exit sections 30 includes a first light exit component 30a that constitutes a portion of the core portion 221 of the waveguide 22 in the first direction D1, and a second light exit component 30b that is a diffraction grating adjacent to the first light exit component 30a. The second light exit component 30b is made of, for example, silicon nitride (SIN). As shown in FIG. 8, FIG. 10, and FIG. 11, the second light exit component 30b is disposed on the one side in the third direction D3 with respect to the first light exit component 30a, and is included in the upper cladding layer 132.

Therefore, the first light exit component 30a and the second light exit component 30b form a pair to constitute the light exit section 30, and the second light exit components 30b are arranged along the waveguide 22 in which the light exit sections 30 to which they belong are provided. In detail, each of the second light exit components 30b is disposed adjacent to one side of the first light exit component 30a in the third direction D3 so as to diffract and emit the light that has leaked out from the first light exit component 30a. In other words, each of the second light exit components 30b is disposed adjacent to the first light exit component 30a so as to emit the guided light 22a from the first light exit component 30a to the outside of the waveguide 22.

Therefore, the guided light 22a propagating through the waveguide 22 is emitted to the outside from each of the light exit sections 30 as indicated by the arrow A6 in FIG. 8. In other words, in the present embodiment, an antenna unit emitting direction Dan, which is a direction in which the optical antenna unit 26 emits the guided light 22a propagating through the waveguide 22 to the outside, is a direction along the third direction D3 as shown in FIG. 11. In FIG. 10 and subsequent figures corresponding to FIG. 10, the waveguides 22 and the second light exit components 30b are hatched for ease of understanding.

The light emitting portions 34 are respectively disposed on the waveguides 22 on the substrate 12. In detail, the light emitting portions 34 are provided one for each of the waveguides 22. Therefore, the optical phased array 18 has the same number of optical emitting portions 34 as the waveguides 22. In the description of the present embodiment, all of the light emitting portions 34 of the optical phased array 18 may be collectively referred to as a light emitting portion group 33. For example, the light emitting portions 34 are disposed at positions that are aligned with each other in the first direction D1.

Each of the light emitting portions 34 is disposed between the phase adjuster 24 and the optical antenna unit 26. With this arrangement, the light emitting portion 34 emits a part of the guided light 22a, which has passed through the phase adjuster 24 and propagates through the waveguide 22, from the waveguide 22 in a direction different from the antenna unit emitting direction Dan in FIG. 11 before the guided light 22a reaches the optical antenna unit 26. For example, in the present embodiment, each of the light emitting portions 34 emits a part of the guided light 22a as an emitted light from each of the light emitting portions 34 to one side and the other side in the second direction D2.

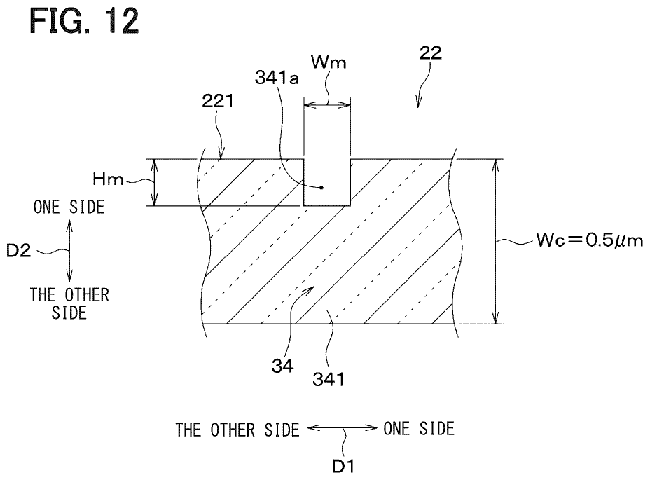

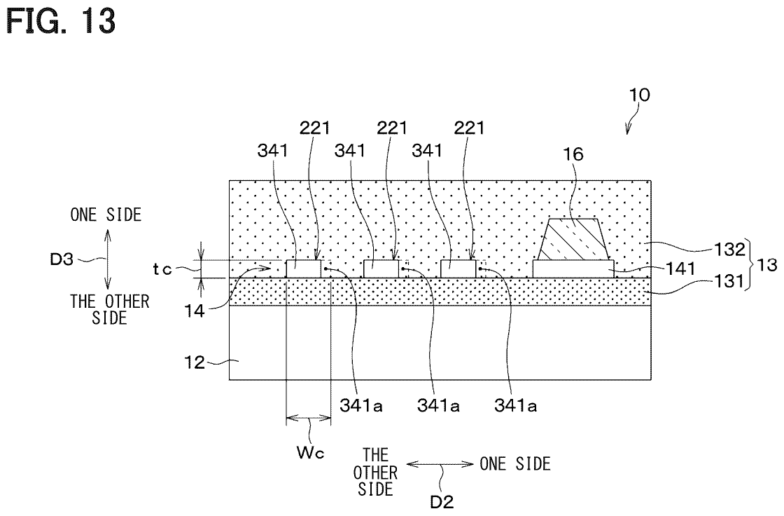

Specifically, as shown in FIG. 10, FIG. 12, and FIG. 13, each of the waveguides 22 has the core width changed portion 341 in which the width dimension Wc, which is the core width of the core portion 221 of the waveguide 22 in the second direction D2, is locally changed. In the present embodiment, the core width of the core portion 221 of the waveguide 22 is locally narrowed at the core width changed portion 341. Each of the light emitting portions 34 is formed by the core width changed portion 341.

In detail, the core width changed portion 341 of the waveguide 22 has a groove 341a formed so as to be cut into the core portion 221 from the one side in the second direction D2 and extend through to the third direction D3. By forming the groove 341a, the width dimension Wc of the core portion 221 at the core width changed portion 341 is smaller than the width dimension Wc of the core portion 221 at a portion of the waveguide 22 adjacent to the core width changed portion 341.

In the present embodiment, the groove 341a has a rectangular cross-sectional shape as shown in FIG. 12, a groove width Wm of the groove 341a in the first direction D1 is “Wm=0.1 μm”, and a groove depth Hm of the groove 341a in the second direction D2 is also “Hm=0.1 μm”. The amount of light emitted from the light emitting portion 34 increases with increase in the size of the groove 341a. Thus, the amount of light emitted from the light emitting portion 34 is adjusted by the size of the groove 341a.

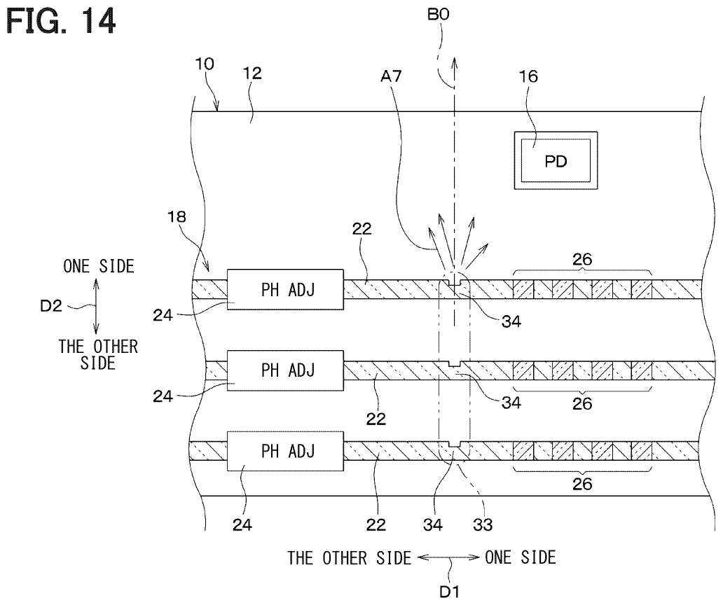

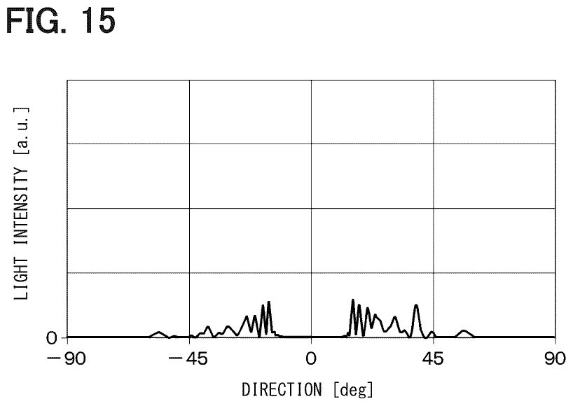

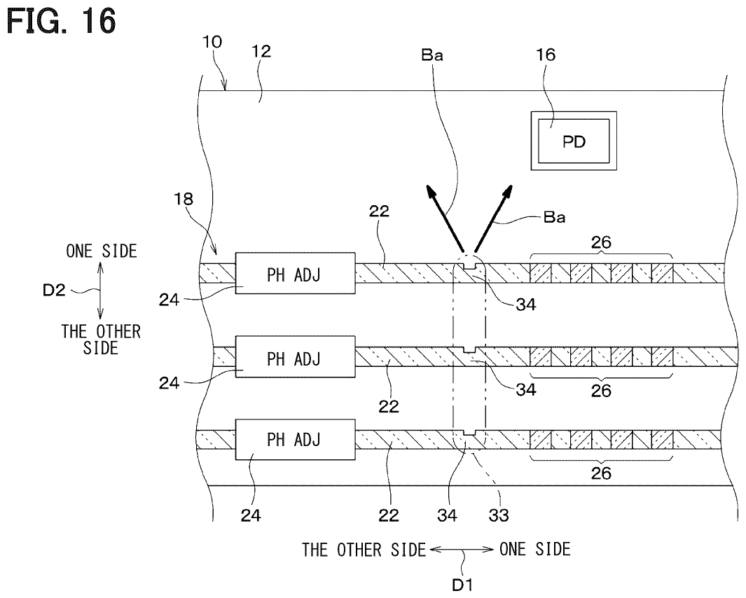

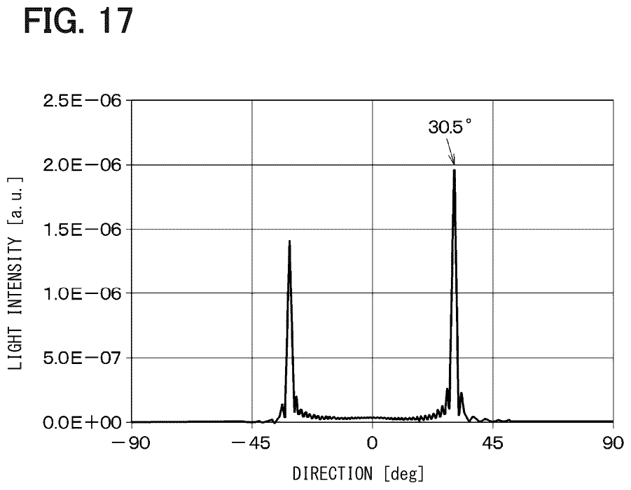

In the optical phased array 18 configured as described above, if the phases of the emitted lights, which are the guided lights 22a emitted from the light emitting portions 34, are not matched, the emitted lights from the light emitting portions 34 will be dispersed as indicated by arrows A7, as shown in FIGS. 14 and 15, and no beam will be formed. In contrast, when the phases of the emitted lights from the light emitting portions 34 are matched with each other, for example when the phases of the emitted lights are the same with each other, an emitted beam Ba composed of the emitted lights from the light emitting portions 34 is formed in a certain direction, as shown in FIG. 16 and FIG. 17.

A direction of the emitted beam Ba, that is, a beam formation direction Dba (see FIG. 10), varies depending on, for example, the wavelength of the guided lights 22a propagating through the waveguides 22. The beam formation direction Dba, that is, the direction of the emitted beam Ba, is information necessary for determining the relative arrangement of the photoelectric converter 16 with respect to the light emitting portion group 33, as will be described later. Therefore, in the present embodiment, the wavelength of the light emitted by the light source 76 is determined in advance, and the beam formation direction Dba is calculated by computer simulation.

In addition, in FIG. 16, two emitted beams Ba traveling from the light emitting portion group 33 to the one side of the second direction D2 are represented by arrows, but two emitted beams Ba are also formed on the other side of the second direction D2 relative to the light emitting portion group 33, similar to the one side. An arrow B0 in FIG. 14 indicates the direction of 0 degrees shown on the horizontal axis in FIG. 15 and FIG. 17.

For example, in the present embodiment, as shown in FIG. 10 and FIG. 17, one of the emitted beams Ba is formed to be oriented along the beam axis Lba in FIG. 10 when viewed in a direction along the third direction D3. In other words, when viewed in the direction along the third direction D3, one of the emitted beams Ba is formed at an angle a of 30.5 degrees with respect to the second direction D2 so as to be positioned on the one side of the first direction D1 toward the one side of the second direction D2 based on the center 33a of the light emitting portion group 33.

Note that, the emitted lights emitted from the light emitting portion 34 disposed on each of the waveguides 22 passes through the other waveguides 22 arranged side by side with respect to the waveguide 22 from which the emitted lights are emitted, and proceed to the one side and the other side in the second direction D2. When the phases of the emitted lights emitted from the light emitting portions 34 are matched with each other, the emitted lights that have passed through the other waveguides 22 and the emitted lights that have not passed through the other waveguides 22 will combine to form the emitted beams Ba.

As shown in FIG. 10 and FIG. 13, the photoelectric converter 16 is arranged on the one side in the second direction D2 with respect to all of the waveguides 22 of the optical phased array 18. In other words, the photoelectric converter 16 is arranged on the one side in the second direction D2 with respect to all of the plurality of light emitting portions 34 of the optical phased array 18.

The photoelectric converter 16 is a photodetector that outputs an electrical signal according to the intensity of light incident on the photoelectric converter 16. The electrical signal output from the photoelectric converter 16 is guided to the outside of the optical waveguide structure 10 by a connection terminal (not shown) provided on the substrate 12. The photoelectric converter 16 is laminated on the one side in the third direction D3 with respect to a base portion 141 which is a part of the core layer 14, and is surrounded by the base portion 141 and the upper cladding layer 132. Specifically, the photoelectric converter 16 in the present embodiment is a photodiode made of germanium (Ge). The output of the photoelectric converter 16 as an electrical signal increases with increase in the intensity of light incident on the photoelectric converter 16.

As shown in FIG. 10, the position of the photoelectric converter 16 is set so that the emitted beam Ba is incident on the photoelectric converter 16 when the phases of the emitted light emitted from the light emitting portions 34 are matched with each other. More specifically, since a plurality of emitted beams Ba are formed, the position of the photoelectric converter 16 is determined so that at least one of the plurality of emitted beams Ba is incident on the photoelectric converter 16.

For example, in the present embodiment, one of the plurality of emitted beams Ba is formed so as to extend along a beam axis Lba in FIG. 10 when viewed in the direction along the third direction D3, as described above. Therefore, when viewed in the direction along the third direction D3, the photoelectric converter 16 is disposed on an extended line of the beam axis Lba. For example, the photoelectric converter 16 is disposed on the one side in the first direction D1 and on the one side in the second direction D2 with respect to the center 33a of the light emitting portion group 33. In addition, the beam axis Lba in FIG. 10 extends through the center 33a of the light emitting portion group 33 in the beam formation direction Dba that is inclined at an angle a with respect to the second direction D2 so that it shifts toward the one side of the first direction D1 as it proceeds toward the one side of the second direction D2.

In the optical waveguide structure 10 configured as described above, as shown in FIG. 9 and FIG. 10, the light emitted from the light source 76 is incident on the light incident unit 19 of the optical phased array 18, and the incident light is distributed to each of the waveguides 22 by the light distribution unit 20. The phases of the guided lights 22a, which are the lights distributed by the light distribution unit 20 and propagate through the respective waveguides 22, are respectively adjusted by the phase adjusters 24, and the guided lights 22a after the phase adjustment travel toward the optical antenna units 26 in the waveguides 22 and are emitted from the optical antenna units 26 to the outside of the optical waveguide structure 10.

However, since the optical phased array 18 of the present embodiment includes the light emitting portions 34. Thus, in each of the waveguides 22, a part of the guided light 22a after the phase adjustment is emitted as the emitted light from the light emitting portion 34 before reaching the optical antenna unit 26. For example, in the present embodiment, the amount of the emitted light emitted from the light emitting portion 34 is about 3% of the amount of the guided light 22a outputted from the phase adjuster 24.

Moreover, the optical phased array 18 of the present embodiment can scan the beam BM in the same manner as the optical phased array 70 of FIG. 1. In other words, in the optical phased array 18 of the present embodiment, the beam BM formed by the lights emitted from the optical antenna units 26 can be formed in any direction by regularly controlling the phases of the guided lights 22a propagating through the respective waveguides 22 with the phase adjusters 24.

In the present embodiment, the emitted lights emitted from the light emitting portions 34 are used to perform phase correction for eliminating variations in the initial phases of the guided lights 22a in the waveguides 22. Specifically, in the phase correction for the guided lights 22a, the phases of the guided lights 22a are respectively adjusted by the phase adjusters 24 so that the output of the photoelectric converter 16 becomes maximum within an adjustable range.

As described above, according to the present embodiment, the light emitting portions 34 are respectively disposed on the waveguides 22 on the substrate 12, as shown in FIG. 10 and FIG. 11. Each of the light emitting portions 34 emits, as the emitted light, a part of the guided light 22a that has passed through the phase adjuster 24 and propagates trough the waveguide 22, from the waveguide 22 in the direction different from the antenna unit emitting direction Dan in FIG. 11. In addition, the photoelectric converter 16 is disposed on the substrate 12 and is arranged on the one side in the second direction D2 with respect to all of the light emitting portions 34 of the optical phased array 18. Furthermore, the position of the photoelectric converter 16 is set so that the emitted beam Ba is incident on the photoelectric converter 16 when the phases of the emitted lights emitted from the light emitting portions 34 of the waveguides 22 are matched with each other.

As a result, a part of the guided light 22a propagating through each of the waveguides 22 is emitted as the emitted light from each of the light emitting portions 34, and when the phases of the emitted lights are matched with each other, the emitted beam Ba formed by the emitted light is incident on the photoelectric converter 16. Therefore, the photoelectric converter 16 can obtain the function of acquiring the guided lights 22a in order to perform the phase correction for restricting the phase variation of the guided lights 22a in the waveguides 22. Furthermore, since the photoelectric converter 16 is disposed on the same substrate 12 as the waveguides 22, it is possible to provide a chip having the waveguides 22 with the function of acquiring the guided lights 22a for the phase correction.

Furthermore, since the photoelectric converter 16 is disposed on the one side of the second direction D2 with respect to all of the light emitting portions 34 of the optical phased array 18, the arrangement of the waveguides 22 is not hindered from being arranged with a narrow pitch due to the arrangement of the photoelectric converter 16. For example, compared to a configuration in which various elements such as photoelectric converters 16 are arranged between waveguides 22 that propagate guided lights 22a, specifically, the configuration of the second reference example described above, it can be said that the arrangement of the waveguides 22 is less likely to be hindered from having a narrow pitch.

Furthermore, according to the present embodiment, as shown in FIG. 10 and FIG. 12, each of the plurality waveguides 22 has the core width changed portion 341 in which the width dimension Wc, which is the core width of the core portion 221 in the second direction D2, is locally changed. Each of the plurality of light emitting portions 34 is formed by the core width changed portion 341. The plurality of light emitting portion 34 can be formed depending on the shapes of the plurality of waveguides 22. Therefore, there is an advantage in that it is easy to provide the plurality of light emitting portion 34 in the manufacture of the optical waveguide structure 10.

Furthermore, according to the present embodiment, the core width changed portion 341 included in each of the plurality of waveguides 22 is a portion where the core width of the core portion 221 is locally narrowed. Therefore, compared to a case where, for example, a core width changed portion 341 is constituted of a portion of each of the plurality of waveguides 22 where the core width locally expands in the second direction D2, there is an advantage in that it is easier to achieve a narrower pitch for arranging the plurality of waveguides 22.

### Second Embodiment

Next, a second embodiment will be described. The present embodiment is explained mainly with respect to points different from those of the first embodiment. In addition, explanations of the same or equivalent portions as those in the above embodiment is omitted or simplified. The same is also true for the description of the later-described embodiments.

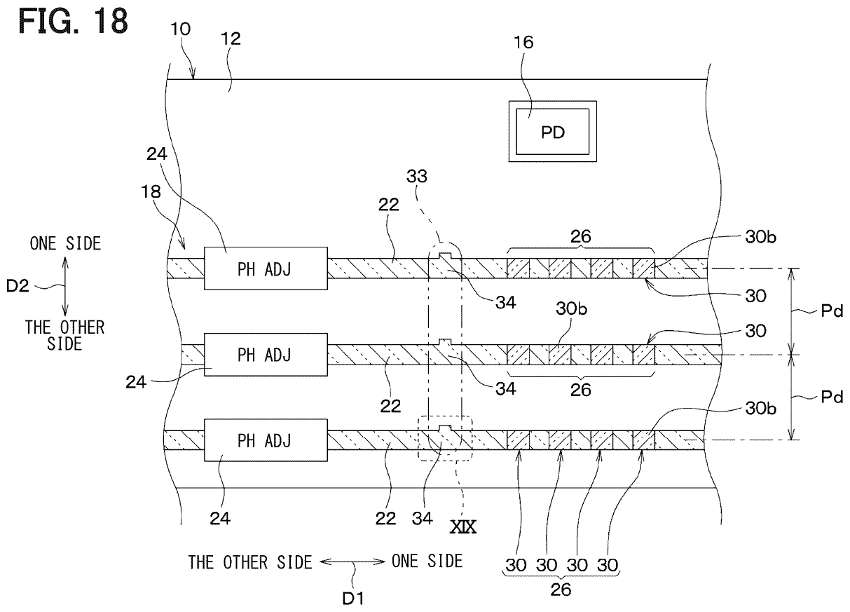

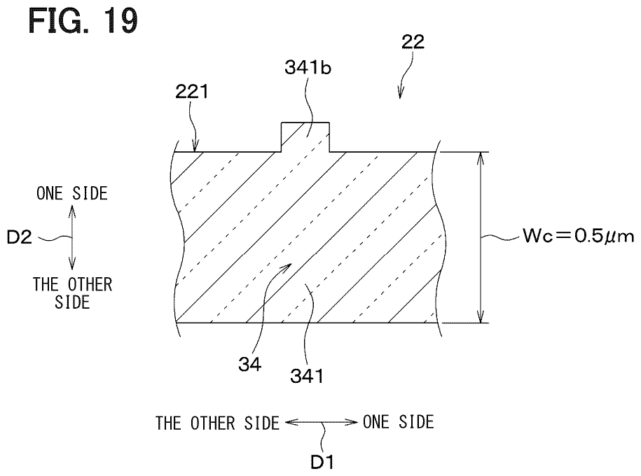

As shown in FIG. 18 and FIG. 19, in the present embodiment, similarly to the first embodiment, the core width changed portion 341 included in each of the plurality of waveguides 22 is a portion where the width dimension Wc, which is the core width of each of the plurality of waveguides 22, is locally changed. Each of the light emitting portions 34 is formed by the core width changed portion 341.

However, in the present embodiment, no groove 341a (see FIG. 12) is formed in the core width changed portion 341. Instead, in the present embodiment, the core width changed portion 341 is formed with a protrusion 341b that protrudes to the one side in the second direction D2. Therefore, the core width changed portion 341 included in each of the plurality of waveguides 22 is a portion where the core width of each of the plurality of waveguides 22 is locally expanded.

The present embodiment is similar to the first embodiment, except for the above described aspects. Thus, the present embodiment can achieve the advantages obtained by the configuration common to the first embodiment described above in a similar manner as in the first embodiment.

### Third Embodiment

Next, a third embodiment will be described. The present embodiment is explained mainly with respect to points different from those of the first embodiment.

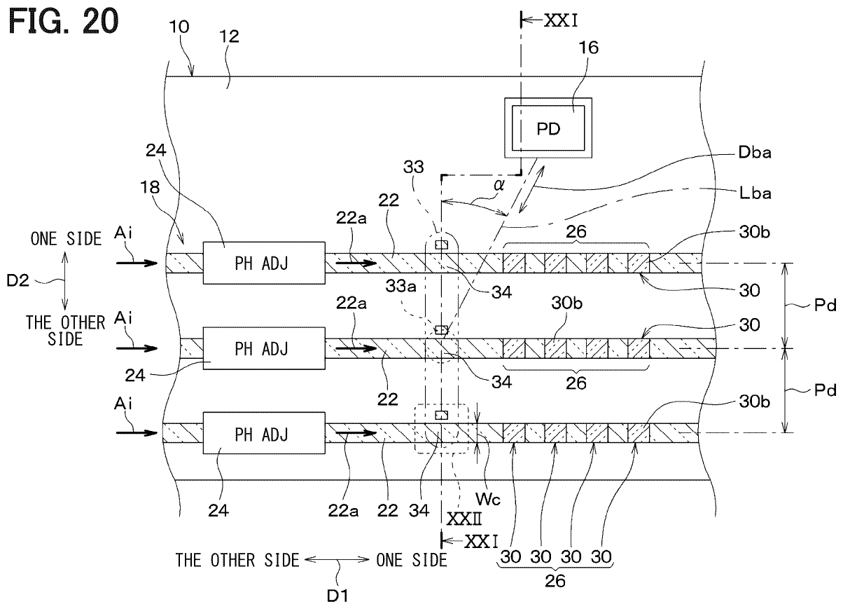

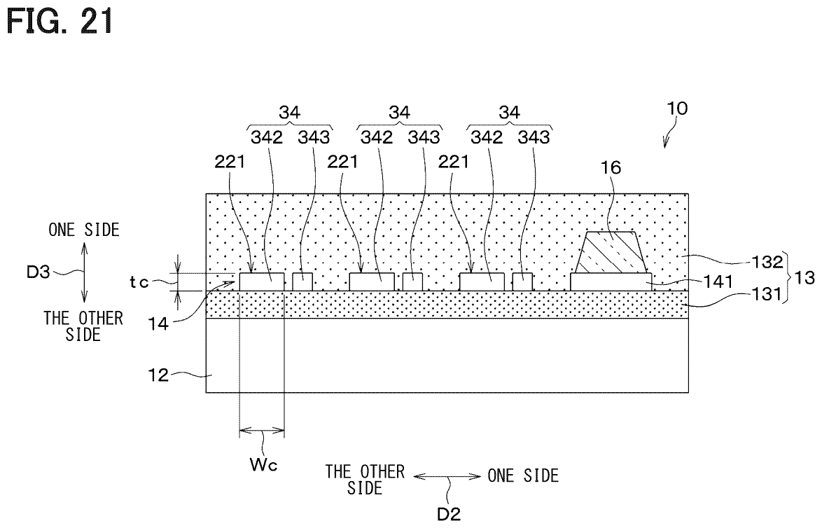

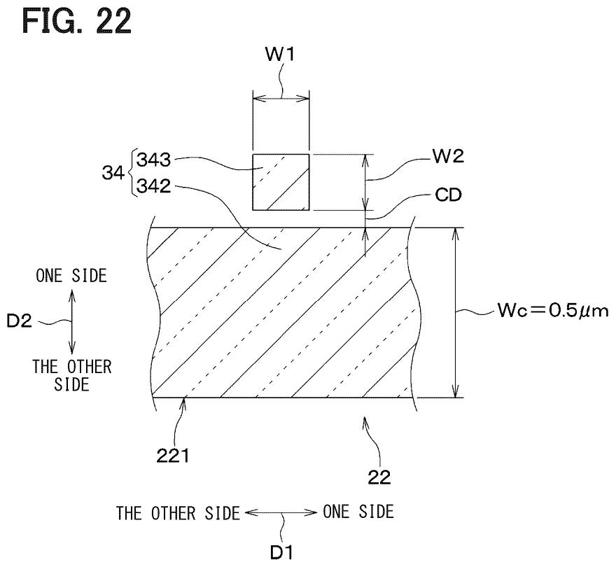

As shown in FIG. 20, FIG. 21 and FIG. 22, in the present embodiment, the structure of the light emitting portion 34 is different from that in the first embodiment, and the groove 341a shown in FIG. 12 is not provided in each of the plurality of waveguides 22. Therefore, each of the plurality of light emitting portion 34 of the present embodiment does not have the core width changed portion 341 shown in FIG. 12.

Specifically, each of the plurality of light emitting portions 34 in the present embodiment includes an emitting component 342 and a closely arranged portion 343. The emitting component 342 constitutes a portion of the core portion 221 in each of the plurality of waveguides 22 in the first direction D1. The closely arranged portion 343 is shifted to the one side in the second direction D2 with respect to the emitting component 342. Specifically, the closely arranged portion 343 is arranged next to the emitting portion 342 at a small interval on the one side in the second direction D2.

In detail, the closely arranged portions 343 respectively provided for the waveguides 22 are formed so as to be laminated on the one side of the substrate 12 in the third direction D3, similar to the plurality of waveguide 22. The closely arranged portions 343 are made of the same material as the core portions 221 of the plurality of waveguides 22, and are included in the same core layer 14 as the core portions 221 of the waveguides 22 in the laminated structure of the optical waveguide structure 10. In other words, the closely arranged portions 343 are made of the same Si as the core portions 221, and has the same thickness dimension tc as the core portions 221.

Furthermore, in each of the light emitting portions 34, the closely arranged portion 343 is arranged adjacent to the one side of the emitting component 342 in the second direction D2 so as to diffract and emit a light that leaks out from the emitting component 342. In other words, in each of the light emitting portions 34, the closely arranged portion 343 is arranged adjacent to the emitting component 342 so as to emit a part of the guided light 22a from the emitting portion 342 to the outside of each of the plurality of waveguides 22.

Each of the closely arranged portions 343 has a rectangular parallelepiped shape. For example, a first width W1, which is a width in the first direction D1 of the closely arranged portion 343, and a second width W2, which is a width in the second direction D2 of the closely arranged portion 343, are “W1=W2=0.3 μm”, and a distance CD between the closely arranged portion 343 and the emitting component 342 in the second direction D2 is “CD=0.1 μm”.

As described above, the closely arranged portion 343 of each of the light emitting portions 34 is shifted in the second direction D2 with respect to the emitting component 342, so that in the present embodiment, each of the light emitting portions 34 emits a part of the guided light 22a to the one side and the other side of the second direction D2.

As described above, according to the present embodiment, each of the light emitting portions 34 includes the emitting component 342 included in the core portion 221 of each of the waveguides 22, and the closely arranged portion 343. The closely arranged portion 343 is arranged adjacent to the emitting component 342 so as to emit a part of the guided light 22a from the emitting component 342, and is shifted in the second direction D2 with respect to the emitting component 342.

Accordingly, it is possible to form a diffraction structure for emitting a part of the guided light 22a from each of the waveguides 22 to the one side and the other side in the second direction D2, away from each of the waveguides 22, rather than directly on each of the waveguides 22. Therefore, even if a dimensional processing precision of the core layer 14 is low, it is possible to design the amount of lights used for phase correction to be smaller than that in the first embodiment, for example. If the amount of lights used for the phase correction is reduced, the amount of lights emitted from the optical antenna units 26 can be increased accordingly.

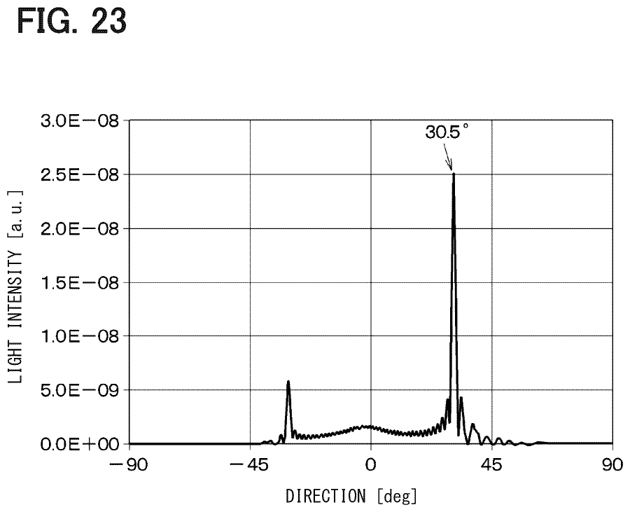

As shown in FIG. 23, in the present embodiment, an emitted beam Ba composed of the emitted lights from the light emitting portions 34 is formed in the same manner as in the first embodiment, and the beam formation direction Dba, which is the direction of the emitted beam Ba, is, for example, the same as in the first embodiment. Therefore, in the present embodiment as well, the relative arrangement of the photoelectric converter 16 with respect to the light emitting portion group 33 is the same as in the first embodiment. However, the light intensity of the emitted beam Ba in the present embodiment is lower than that in the first embodiment. The direction constituting the horizontal axis in the coordinate system of FIG. 23 is the same as the direction constituting the horizontal axis in the coordinate system of FIG. 17.

Furthermore, according to the present embodiment, each of the closely arranged portions 343 is made of the same material as the core portions 221 of the waveguides 22, and is included in the same core layer 14 as the core portions 221 of the waveguides 22 in the layered structure of the optical waveguide structure 10. Therefore, it is possible to easily form the closely arranged portions 343 while restricting an increase in the number of manufacturing processes caused by providing the plurality of closely arranged portions 343.

The present embodiment is similar to the first embodiment, except for the above described aspects. Thus, the present embodiment can achieve the advantages obtained by the configuration common to the first embodiment described above in a similar manner as in the first embodiment.

### Fourth Embodiment

A fourth embodiment is described next. The present embodiment will be explained mainly with respect to portions different from those of the third embodiment.

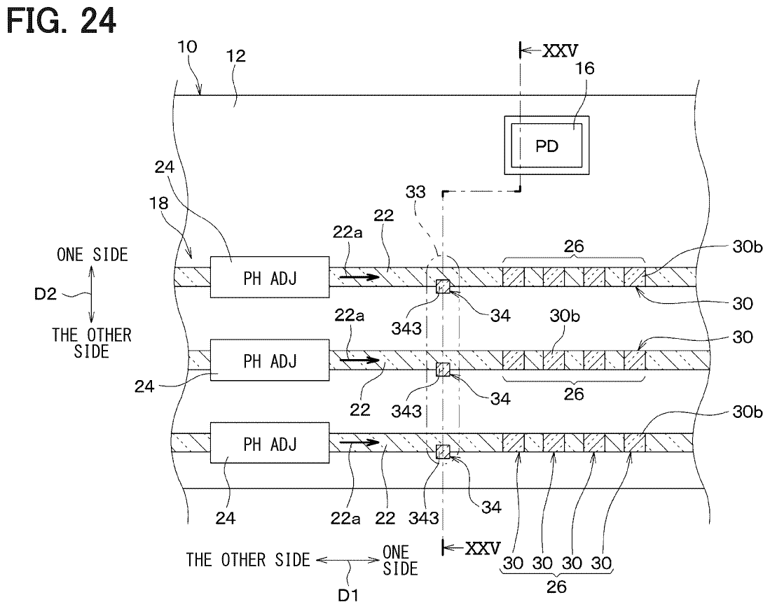

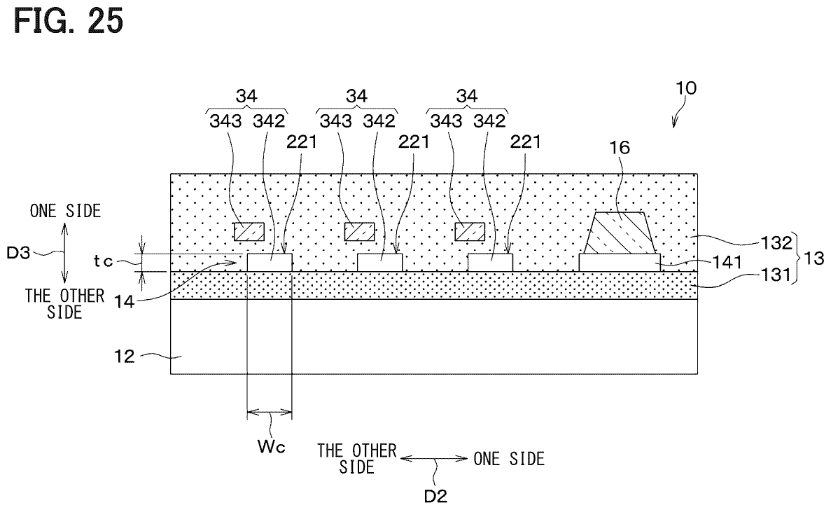

As shown in FIG. 24 and FIG. 25, in the present embodiment, each of the plurality of light emitting portions 34 includes the emitting component 342 and the closely arranged portion 343, but the arrangement of the closely arranged portion 343 is different from that in the third embodiment.

Specifically, in the present embodiment, in each of the plurality of light emitting portions 34, the closely arranged portion 343 is arranged to be shifted to the other side in the second direction D2 with respect to the emitting component 342. The closely arranged portion 343 is not included in the core layer 14, and is arranged away from the emitting component 342 on the one side of the third direction D3 with a small gap therebetween, and a portion of the closely arranged portion 343 overlaps a portion of the emitting component 342 on the one side of the third direction D3.

The closely arranged portion 343 may be made of the same material as the core portion 221 of each of the waveguides 22. However, in the present embodiment, the closely arranged portion 343 is made of a material different from that of the core portion 221, for example, SiN.

Also in the present embodiment, the closely arranged portion 343 of each of the light emitting portions 34 is shifted in the second direction D2 with respect to the emitting component 342, so that each of the light emitting portions 34 emits a part of the guided light 22a from each of the light emitting portions 34 to the one side and the other side of the second direction D2.

Aside from the above described aspects, the present embodiment is the same as the third embodiment. Thus, the present embodiment can achieve the advantages obtained by the configuration common to the third embodiment described above in a similar manner as in the third embodiment.

### Fifth Embodiment

A fifth embodiment is described next. The present embodiment is explained mainly with respect to points different from those of the first embodiment.

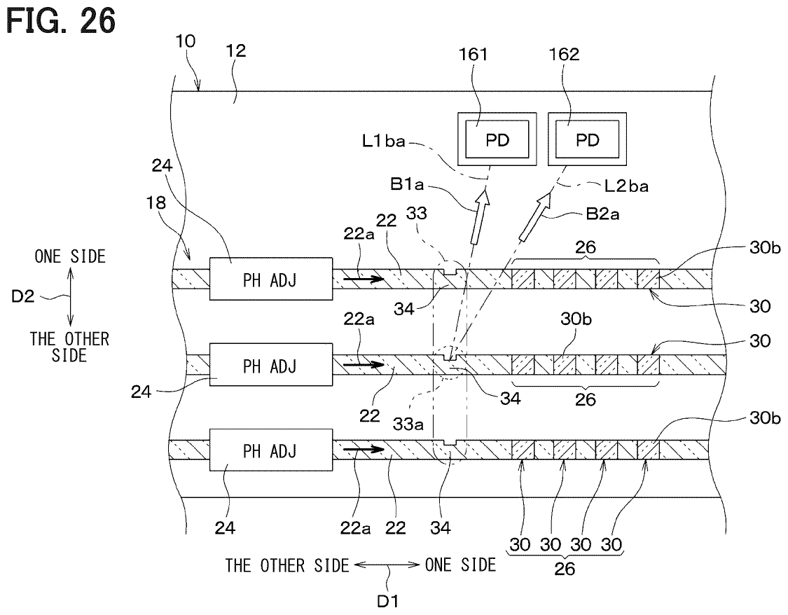

As shown in FIG. 26, in the present embodiment, two photoelectric converters 16 are disposed on the substrate 12. One of the two photoelectric converters 16 is referred to as a first photoelectric converter 161 and the other is referred to as a second photoelectric converter 162. The first and second photoelectric converters 161, 162 are each a photodetector identical to the photoelectric converter 16 of the first embodiment, and the arrangement of the first and second photoelectric converters 161, 162 in the third direction D3 is the same as that of the photoelectric converter 16 of the first embodiment.

The first photoelectric converter 161 is arranged in a direction different from a direction in which the second photoelectric converter 162 is arranged, based on the center 33a of the light emitting portion group 33, when viewed in the direction along the third direction D3.

Specifically, the first photoelectric converter 161 is disposed so as to overlap a first beam axis L1ba that extends through the center 33a of the light emitting portion group 33 when viewed in the direction along the third direction D3. The first beam axis L1ba is a straight line along a first emitted beam B1a indicated by an arrow in FIG. 26. The first emitted beam B1a is one of a plurality of emitted beams Ba formed by the emitted lights when the wavelength of the light emitted by the light source 76 is a predetermined first wavelength λ1 and the phases of the emitted lights from the plurality of light emitting portions 34 are matched with each other. In this manner, the arrangement of the first photoelectric converter 161 is set so as to correspond to the case where the wavelength of the light emitted by the light source 76 is the first wavelength λ1.

The second photoelectric converter 162 is disposed so as to overlap with a second beam axis L2ba that extends through the center 33a of the light emitting portion group 33 when viewed in the direction along the third direction D3. The second beam axis L2ba intersects with the first beam axis L1ba and is a straight line along the second emitted beam B2a indicated by an arrow in FIG. 26. The second emitted beam B2a is one of the plurality of emitted beams Ba formed by the emitted lights when the wavelength of the light emitted by the light source 76 is a predetermined second wavelength λ2 different from the first wavelength λ1 and the phases of the emitted lights from the plurality of light emitting portions 34 are matched with each other. In this manner, the arrangement of the second photoelectric converter 162 is set so as to correspond to the case where the wavelength of the light emitted by the light source 76 is the second wavelength λ2.

The direction and arrangement of the first beam axis L1ba along the first emitted beam B1a can be obtained by computer simulation, with the wavelength of the light emitted by the light source 76 being determined as the first wavelength λ1 in advance. Similarly, the direction and arrangement of the second beam axis L2ba along the second emitted beam B2a can be determined by computer simulation, with the wavelength of the light emitted by the light source 76 being determined as the second wavelength λ2 in advance.

As described above, according to the present embodiment, the first photoelectric converter 161 is arranged in the direction different from the direction in which the second photoelectric converter 162 is arranged, based on the center 33a of the light emitting portion group 33, when viewed in the direction along the third direction D3.

If the wavelength of the light emitted by the light source 76 is different, then the directions of the emitted beams B1a, B2a formed by the emitted lights will differ depending on the wavelength when the phases of the emitted lights from the light emitting portions 34 are matched with each other. Therefore, the optical waveguide structure 10 can be provided with a function of acquiring the guided lights 22a of the waveguides 22 so as to correspond to cases in which the light emitted by the light source 76 is switched between a plurality of different wavelengths and to perform phase correction at each of the wavelengths.

The present embodiment is similar to the first embodiment, except for the above described aspects. Thus, the present embodiment can achieve the advantages obtained by the configuration common to the first embodiment described above in a similar manner as in the first embodiment.

The present embodiment is a modification based on the first embodiment and can also be combined with any of the second to the fourth embodiments described above.

### Sixth Embodiment

A sixth embodiment is described next. The present embodiment is explained mainly with respect to points different from those of the first embodiment.

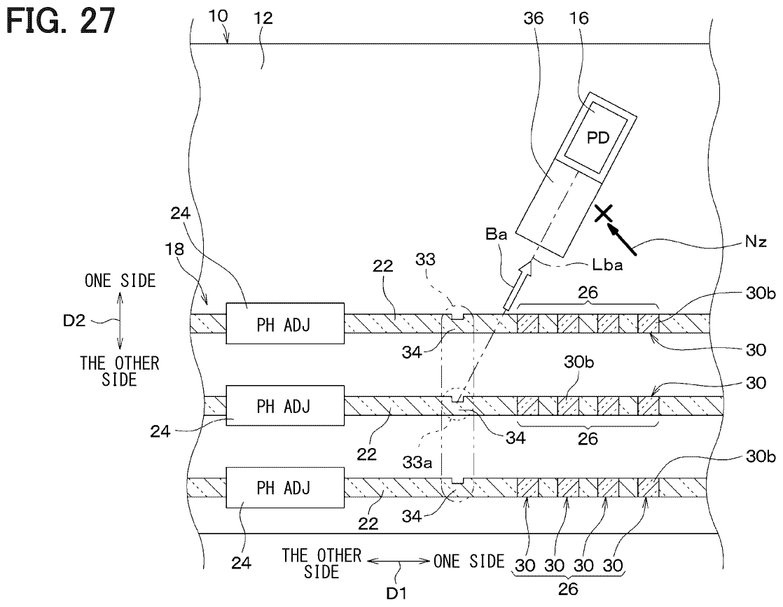

As shown in FIG. 27, the optical waveguide structure 10 includes a light receiving waveguide 36 connected to the photoelectric converter 16. The light receiving waveguide 36 is a waveguide that guides, to the photoelectric converter 16, the emitted beam Ba formed by the emitted lights emitted from the light emitting portion group 33 when the phases of the emitted lights from the light emitting portions 34 are matched with each other. Therefore, when viewed in the direction along the third direction D3, the light receiving waveguide 36 extends from the photoelectric converter 16 toward the center 33a of the light emitting portion group 33.

For example, the light receiving waveguide 36 includes a core portion formed at the same laminated position as the photoelectric converter 16 in the third direction D3 in the laminated structure of the optical waveguide structure 10, and a cladding portion surrounding the core portion in the cladding layer 13 in FIG. 13. The core portion of the light receiving waveguide 36 is made of, for example, Si.

As described above, according to the present embodiment, the light receiving waveguide 36 extends from the photoelectric converter 16 toward the center 33a of the light emitting portion group 33 when viewed in the direction along the third direction D3. Thus, the light receiving waveguide 36 is disposed so as to be parallel or approximately parallel to the emitted beam Ba emitted from the light emitting portion group 33.

Therefore, the emitted beam Ba is guided to the photoelectric converter 16 through the light receiving waveguide 36, while the light receiving waveguide 36 prevents disturbance light Nz, which is oriented in a direction intersecting the emitted beam Ba, from being incident on the photoelectric converter 16. As a result, the phase correction using the emitted beam Ba incident on the photoelectric converter 16 can be performed with high accuracy.

The present embodiment is similar to the first embodiment, except for the above described aspects. Thus, the present embodiment can achieve the advantages obtained by the configuration common to the first embodiment described above in a similar manner as in the first embodiment.

Although the present embodiment is a modification based on the first embodiment, the present embodiment can be combined with any of second to fifth embodiments described above.

### Seventh Embodiment

A seventh embodiment is described next. The present embodiment will be explained primarily with respect to portions different from those of the sixth embodiment.

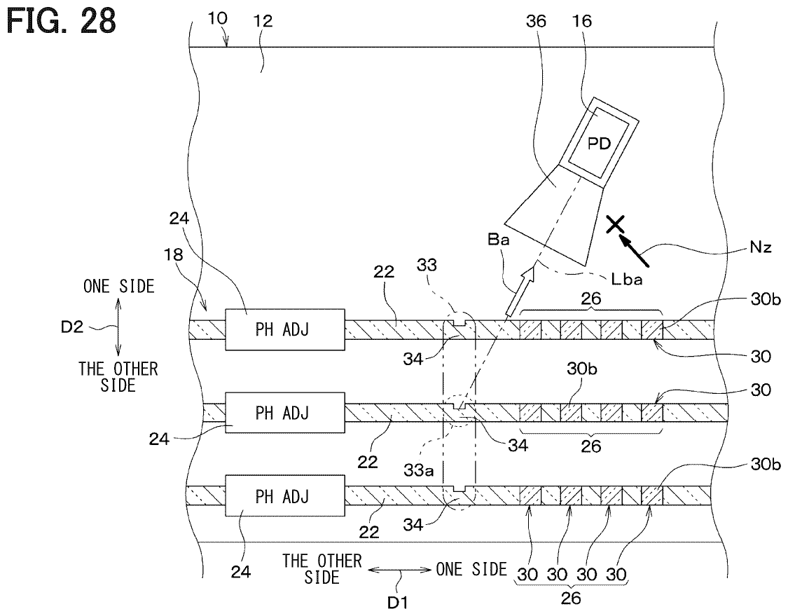

As shown in FIG. 28, when viewed in the direction along the third direction D3, a width of the light receiving waveguide 36 increases with increase in distance from the photoelectric converter 16 along the extension direction of the receiving waveguide 36, that is, the extension direction of the beam axis Lba. In other words, a tip end of the light receiving waveguide 36 that is close to the light emitting portion group 33 is wider than a base end of the light receiving waveguide 36 that is close to the photoelectric converter 16.

As described above, according to the present embodiment, when viewed in the direction along the third direction D3, the width of the light receiving waveguide 36 increases with increase in distance from the photoelectric converter 16 along the direction in which the light receiving waveguide 36 extends. Therefore, a light receiving angle at which the light receiving waveguide 36 can receive lights from the light emitting portion group 33 becomes narrower. In other words, the directivity of the light receiving waveguide 36 when receiving the lights from the light emitting portion group 33 becomes high. As a result, the phase correction can be performed with high accuracy, as compared with the case where the light receiving waveguide 36 has a shape elongated with a constant width, for example.

Aside from the above described aspects, the present embodiment is the same as the sixth embodiment. Further, in the present embodiment, effects similar to those of the sixth embodiment described above can be obtained in the same manner as in the sixth embodiment.

### Eighth Embodiment

An eighth embodiment is described next. The present embodiment is explained mainly with respect to points different from those of the first embodiment.

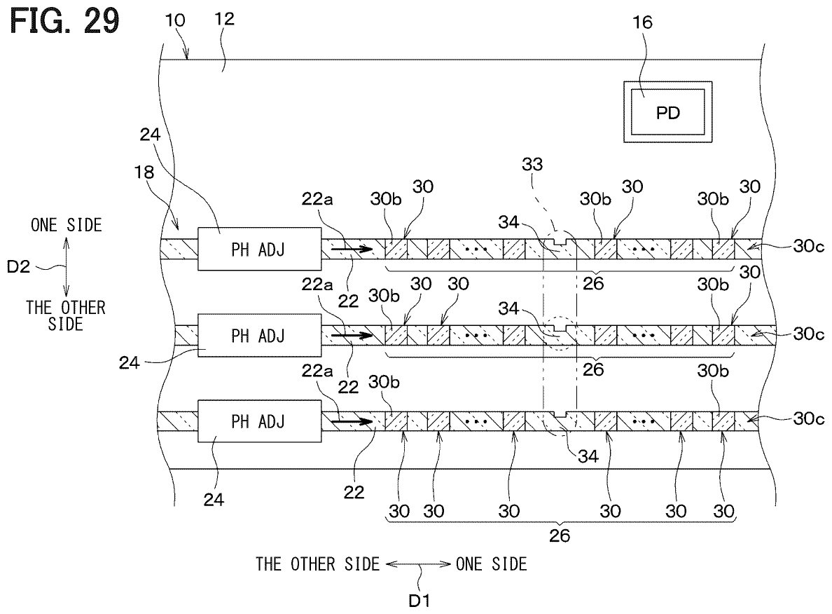

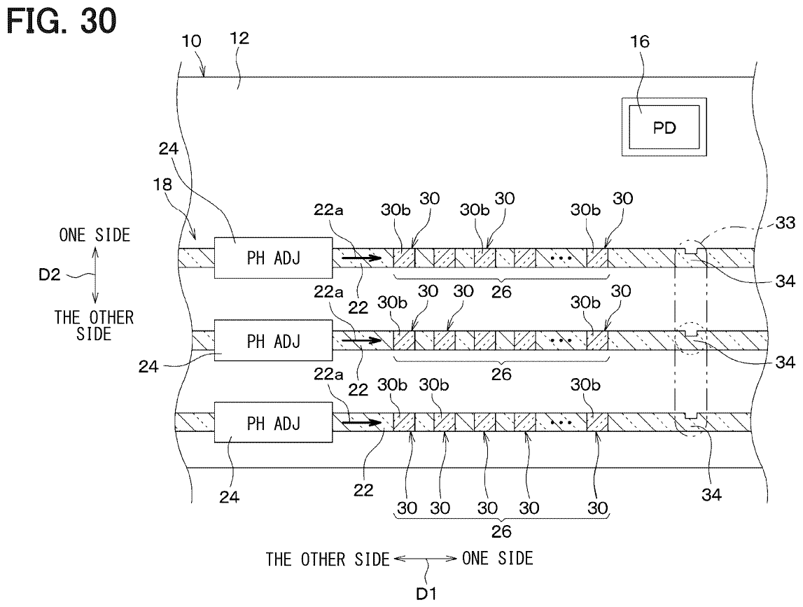

As shown in FIG. 29, in the present embodiment, the position of the light emitting portion 34 in each of the waveguides 22 is different from that in the first embodiment. In addition, in FIG. 29 and FIG. 30 described later, “ . . . ” shown between adjacent light exit sections 30 means that a plurality of light exit sections 30 are not shown.

Specifically, each of the light emitting portions 34 in the present embodiment is disposed in the middle of a light exit section row 30c formed by a plurality of light exit sections 30 for each of the plurality of waveguides 22. For example, in each of the waveguides 22, some light exit sections 30 are disposed on the one side of the light emitting portion 34 in the first direction D1, and the other light exit sections 30 are disposed on the other side of the light emitting portion 34 in the first direction D1.

Since each of the waveguides 22 is actually formed with some tolerance during manufacturing, the guided light 22a travels through each of the waveguides 22 with a slight change in the phase of the guided light 22a.

According to the present embodiment, each of the light emitting portions 34 is disposed in the middle of the light exit section row 30c formed by the plurality of light exit sections 30 for each of the waveguides 22, as described above. Accordingly, the emitted beam Ba incident on the photoelectric converter 16 from the light emitting portion group 33 is composed of lights emitted from portions of the waveguides 22 that overlap with the optical antenna units 26.

Therefore, compared to the case where the light emitting portions 34 are disposed on the one side or the other side of the optical antenna units 26 in the first direction D1 on the waveguides 22, the phase correction can be performed so that the phases of the emitted lights from the optical antenna units 26 are matched with high precision. As a result, it becomes possible to perform scanning with the beam BM formed by the lights emitted from the optical antenna units 26 with high accuracy.

The present embodiment is similar to the first embodiment, except for the above described aspects. Thus, the present embodiment can achieve the advantages obtained by the configuration common to the first embodiment described above in a similar manner as in the first embodiment.

The present embodiment is a modification based on the first embodiment and can also be combined with any of the second to the seventh embodiments described above.

### Ninth Embodiment

A ninth embodiment is described next. The present embodiment is explained mainly with respect to points different from those of the first embodiment.

As shown in FIG. 30, in the present embodiment, the position of the light emitting portion 34 in each of the waveguides 22 is different from that in the first embodiment.

Specifically, in the present embodiment, the light emitting portion 34 is disposed on the opposite side to the phase adjuster 24 with respect to the optical antenna unit 26 in each of the plurality of waveguides 22. In other words, in each of the plurality of waveguides 22, the light emitting portion 34 is disposed on the one side of the optical antenna unit 26 in the first direction D1.

Therefore, the emitted beam Ba for phase correction can be formed using the light that remains without being emitted from the optical antenna unit 26, so that phase correction can be performed without wasting energy.

The present embodiment is similar to the first embodiment, except for the above described aspects. Thus, the present embodiment can achieve the advantages obtained by the configuration common to the first embodiment described above in a similar manner as in the first embodiment.

The present embodiment is a modification based on the first embodiment and can also be combined with any of the second to the seventh embodiments described above.

### Other Embodiments

In each of the above-described embodiments, three waveguides 22 are provided as shown in FIG. 10, for example. However, the number of waveguides 22 may be two, or four or more.

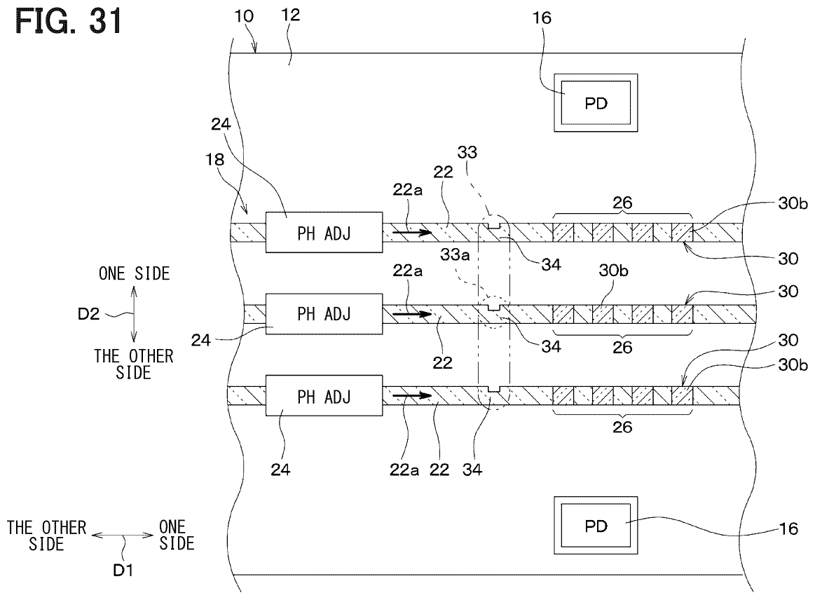

In the first embodiment described above, as shown in FIG. 10, the photoelectric converter 16 is disposed on the one side of the second direction D2 with respect to all of the light emitting portions 34 of the optical phased array 18. However, this arrangement is just one example. For example, the photoelectric converter 16 may be disposed on the other side of the second direction D2 with respect to all of the light emitting portions 34, that is on the opposite side of the plurality of waveguides 22 from the side on which the grooves 341a of the light emitting portions 34 are formed. Furthermore, as shown in FIG. 31, the photoelectric converters 16 may be disposed on both the one side and the other side of all of the plurality of light emitting portions 34 in the second direction D2. This is because each of the plurality of light emitting portions 34 emits a part of the guided light 22a to both the one side and the other side in the second direction D2. Even if the photoelectric converter 16 is disposed on the other side of the second direction D2 with respect to all of the plurality of light emitting portions 34 as described above, the photoelectric converter 16 does not hinder the plurality of waveguides 22 being arranged at a narrow pitch, as in the first embodiment. This is also true in the case where the photoelectric converters 16 are disposed on both sides of all the plurality of light emitting portions 34 in the second direction D2 as described above.

In each of the above-described embodiments, for example, the substrate 12 shown in FIG. 11 is made of Si, the cladding layer 13 is made of SiO₂, the core layer 14 is made of Si, and the second light exit components 30b are made of SiN. However, these materials are just examples. Each of these components may be made of other materials.

For example, the cladding layer 13 may be made of any one of SiN, SiON, LN, InGaAsP, and InP. It is also assumed that the core layer 14 is made of any one of SiO₂, SiN, SiON, LN, InGaAsP, and InP doped with impurities. However, the refractive index of the core layer 14 needs to be higher than the refractive index of the cladding layer 13, and the second light exit components 30b need to have a different refractive index from that of the cladding layer 13.

In each of the above-described embodiments, the photoelectric converter 16 shown in FIG. 11 is made of Ge, for example. However, the photoelectric converter 16 may be made of a material other than Ge. For example, the material of the photoelectric converter 16 is appropriately selected depending on the wavelength of the guided light 22a propagating through each of the plurality of waveguides 22.

In each of the above-described embodiments, as shown in FIG. 11, the antenna unit emitting direction Dan in which each of the plurality of optical antenna units 26 emits light to the outside is the direction along the third direction D3. However, this is merely an example. For example, each of the optical antenna units 26 may have a structure different from that shown in FIG. 8 and may be configured to emit light to the one side in the first direction D1.

The present disclosure is not limited to the above-described embodiments, and can be implemented in various modifications. The above-described embodiments are not independent of each other, and can be appropriately combined except when the combination is obviously impossible.

The constituent element(s) of each of the above embodiments is/are not necessarily essential unless it is specifically stated that the constituent element(s) is/are essential in the above embodiment, or unless the constituent element(s) is/are obviously essential in principle. Further, in each of the above-described embodiments, when numerical values such as the number, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Furthermore, a material, a shape, a positional relationship, or the like, if specified in the above-described embodiments, is not necessarily limited to the specific material, shape, positional relationship, or the like unless it is specifically stated that the material, shape, positional relationship, or the like is necessarily the specific material, shape, positional relationship, or the like, or unless the material, shape, positional relationship, or the like is obviously necessary to be the specific material, shape, positional relationship, or the like in principle.

What is claimed is:

1. An optical waveguide structure comprising:
a substrate;
a plurality of waveguides disposed on the substrate, extending in a first direction, arranged at a uniform pitch in a second direction that is perpendicular to the first direction, and configured to propagate respective lights;
a plurality of phase adjusters respectively disposed on the plurality of waveguides on the substrate, and configured to control phases of the respective lights propagating through the plurality of waveguides;
a plurality of optical antenna units respectively disposed on the plurality of waveguides on the substrate, and configured to emit the respective lights that have passed through the plurality of phase adjusters and propagate through the plurality of waveguides in an antenna unit emitting direction;
a plurality of light emitting portions respectively disposed on the plurality of waveguides on the substrate, and configured to emit a part of the respective lights that have passed through the plurality of phase adjusters and propagate through the plurality of waveguides as emitted lights in a direction different from the antenna unit emitting direction; and
a photoelectric converter disposed on the substrate, disposed on one side, another side, or both sides in the second direction with respect to all of the plurality of light emitting portions, and configured to output an electrical signal corresponding to an intensity of a light incident on the photoelectric converter, wherein
a position of the photoelectric converter is set so that an emitted beam formed by the emitted lights emitted from the plurality of light emitting portions is incident on the photoelectric converter when phases of the emitted lights are matched with each other.

2. The optical waveguide structure according to claim 1, wherein
each of the plurality of waveguides includes a core portion,
each of the plurality of waveguides has a core width changed portion in which a core width of the core portion in the second direction is locally changed, and
each of the plurality of light emitting portions is formed by the core width changed portion.

3. The optical waveguide structure according to claim 1, wherein
each of the plurality of waveguides includes a core portion,
each of the plurality of waveguides has a core width changed portion in which a core width of the core portion in the second direction is locally narrowed, and
each of the plurality of light emitting portions is formed by the core width changed portion.

4. The optical waveguide structure according to claim 1, wherein
each of the plurality of waveguides includes a core portion,
each of the plurality of light emitting portions includes an emitting component and a closely arranged portion,
the emitting component is included in the core portion, and
the closely arranged portion is disposed adjacent to the emitting component and shifted in the second direction with respect to the emitting component so as to emit a part of a light from the emitting component.

5. The optical waveguide structure according to claim 4, wherein
the closely arranged portion that is included in each of the plurality of light emitting portions and the plurality of waveguides are laminated on the substrate, and
the closely arranged portion is made of a same material as the core portion, and is included in a same layer as the core portion.

6. The optical waveguide structure according to claim 1, wherein
the photoelectric converter includes a first photoelectric converter and a second photoelectric converter, and
when viewed in a direction along a third direction that is perpendicular to the first direction and the second direction, the first photoelectric converter is disposed in a direction different from a direction in which the second photoelectric converter is disposed, based on a center of a light emitting portion group composed of the plurality of light emitting portions.

7. The optical waveguide structure according to claim 1, further comprising
a light receiving waveguide configured to guide the emitted beam to the photoelectric converter, wherein
when viewed in a direction along a third direction that is perpendicular to the first direction and the second direction, the light receiving waveguide extends from the photoelectric converter toward a center of a light emitting portion group composed of the plurality of light emitting portions.

8. The optical waveguide structure according to claim 7, wherein
when viewed in the direction along the third direction, a width of the light receiving waveguide increases with increase in distance from the photoelectric converter along an extending direction of the light receiving waveguide.

9. The optical waveguide structure according to claim 1, wherein
each of the plurality of optical antenna units has a plurality of light exit sections arranged along each of the plurality of waveguides to form a light exit section row and configured to emit lights from each of plurality of waveguides, and
each of the plurality of light emitting portions is disposed in a middle of the light exit section row in each of the plurality of waveguides.

10. The optical waveguide structure according to claim 1, wherein
in each of the plurality of waveguides, each of the plurality of light emitting portions is disposed on an opposite side to each of the plurality of phase adjusters with respect to each of the plurality of optical antenna units.
